(19) United States
(12) Patent Application Publication
(10) Pub. No.: US 2009/0119317 A1
(43) Pub. Date: May 7, 2009

(54) CATCH PHRASE GENERATION DEVICE

(75) Inventors: Masahiro Asaoka, Kawasaki (JP); Yoshio Nakao, Kawasaki (JP); Koji Maruhashi, Kawasaki (JP); Hiroshi Yamakawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/259,855

(22) Filed: Oct. 28, 2008

(30) Foreign Application Priority Data
Nov. 5, 2007 (JP) 2007-287874

(51) Int. Cl. G06F 17/30

(52) U.S. Cl. 707/100; 707/E17.044

(57) ABSTRACT

A catch phrase generation device stores keywords in association with each other. Each keyword indicates a characteristic of a user, and a property to which each of keywords belongs. A plurality of templates are also stored. Each template has an insertion section for which a keyword property that should be inserted is determined in advance. A template corresponding to guidance information based on a predetermined condition is selected. A keyword acquisition unit analyzes an access history, which has been created by the user or to which the user has made reference, and acquires, based on an analyzed result, a stored keyword.

A catch phrase generation unit selects, from among the keywords acquired by the keyword acquisition unit, a keyword belonging to a property identical to the property determined for the insertion section of the selected template, and inserts the selected keyword into the insertion section of the template.

### CROSS-REFERENCE TO RELATED APPLICATIONS

This application is based upon and claims the benefit of priority of prior Japanese Patent Application No. 2007-287874, filed on Nov. 5, 2007, the entire contents of which are incorporated herein by reference.

### FIELD

The embodiments discussed herein are related to a device generating catch phrases from guidance information desired to be provided to a user.

### BACKGROUND

With the development of the Internet, services for distributing guidance information for websites (such as services provided by websites and/or products published on websites) are now being widely used. In general, such guidance information is often assigned a catch phrase for guiding a user of a guidance information distribution destination to a particular web site (i.e., a brief natural linguistic expression for making a service and/or a product provided by the website more appealing).

### SUMMARY

In keeping with one aspect of this invention, catch phrase generation device includes:

keyword storage unit that stores, in association with each other, a plurality of keywords each indicating a characteristic of a user, and a property to which each of the plurality of keywords belongs;

template storage unit that stores a plurality of templates each having an insertion section for which a keyword property that should be inserted is determined in advance;

template selection unit that stores, from the template storage unit, a template corresponding to guidance information based on a predetermined condition;

keyword acquisition unit that analyzes an access history, which has been created by the user or to which the user has made reference, and acquiring, based on an analyzed result, a keyword stored in the keyword storage unit; and

catch phrase generation unit that selects, from among the keywords acquired by the keyword acquisition unit, a keyword belonging to a property identical to the property determined for the insertion section of the template selected from the template storage unit by the template selection unit, and inserting the selected keyword into the insertion section of the template, thereby generating a catch phrase.

### BRIEF DESCRIPTION OF DRAWINGS

FIG. 1 is a system configuration diagram showing an overall configuration of a system including a catch phrase generation device according to Embodiment 1.

FIG. 2 is a block diagram showing a configuration of the catch phrase generation device according to Embodiment 1.

FIG. 3 is a diagram showing exemplary information stored in a template DB.

FIG. 4 is a diagram showing exemplary information stored in an action history DB.

FIG. 5 is a diagram showing exemplary information stored in a keyword DB.

FIG. 6 is a diagram showing exemplary information stored in a keyword conversion DB.

FIG. 7 is a flow chart showing the flow of overall process steps performed in the catch phrase generation device according to Embodiment 1.

FIG. 8 is a flow chart showing the flow of guidance information analysis process steps performed in the catch phrase generation device according to Embodiment 1.

FIG. 9 is a diagram showing exemplary guidance information.

FIG. 10 is a diagram showing an example of morphological analysis.

FIG. 11 is a diagram showing exemplary information stored in the keyword DB.

FIG. 12 is a flow chart showing the flow of template selection process steps performed in the catch phrase generation device according to Embodiment 1.

FIG. 13 is a diagram showing an example of a template group.

FIG. 14 is a flow chart showing the flow of action history extraction process steps performed in the catch phrase generation device according to Embodiment 1.

FIG. 15 is a diagram showing an example of an access history (bulletin board posting).

FIG. 16 is a diagram showing an example of morphological analysis.

FIG. 17 is a diagram showing examples of action history extraction results.

FIG. 18 is a flow chart showing the flow of matching process steps performed in the catch phrase generation device according to Embodiment 1.

FIG. 19 is a diagram showing sets from templates.

FIG. 20 is a diagram showing an example of calculation of the degree of demand.

FIG. 21 is a diagram showing an example of calculation of the degree of association.

FIG. 22 is a diagram showing examples of keyword type conversion stored in the keyword conversion DB.

FIG. 23 is a diagram showing examples of selection of demand point candidates from the degree of demand and the degree of association.

FIG. 24 is a diagram showing examples of results obtained by executing matching process steps for a user terminal A.

FIG. 25 is a diagram showing examples of results obtained by executing matching process steps for a user terminal B.

FIG. 26 is a flow chart showing the flow of catch phrase generation process steps performed in the catch phrase generation device according to Embodiment 1.

FIG. 27 is a diagram showing an example of catch phrase selection for the user terminal A.

FIG. 28 is a diagram showing an example of catch phrase selection for the user terminal B.

FIG. 29 is a flow chart showing the flow of guidance information analysis process steps performed in a catch phrase generation device according to Embodiment 2.

FIG. 30 is a diagram showing examples of guidance point candidate, default catch phrase, and application condition according to Embodiment 2.

FIG. 31 is a diagram showing exemplary information stored in a keyword DB according to Embodiment 2.

FIG. 32 is a flow chart showing the flow of template selection process steps performed in the catch phrase generation device according to Embodiment 2.

FIG. 33 is a diagram showing an example of a template group according to Embodiment 2.

FIG. 34 is a flow chart showing the flow of action history extraction process steps performed in the catch phrase generation device according to Embodiment 2.

FIG. 35 is a diagram showing an example of an access history (web log posting) according to Embodiment 2.

FIG. 36 is a diagram showing an example of morphological analysis according to Embodiment 2.

FIG. 37 is a diagram showing examples of action history extraction results according to Embodiment 2.

FIG. 38 is a flow chart showing the flow of matching process steps performed in the catch phrase generation device according to Embodiment 2.

FIG. 39 is a diagram showing sets from templates according to Embodiment 2.

FIG. 40 is a diagram showing an example of demand point extraction according to Embodiment 2.

FIG. 41 is a diagram showing an example of calculation of the degree of demand according to Embodiment 2.

FIG. 42 is a diagram showing an example of calculation of the degree of association according to Embodiment 2.

FIG. 43 is a diagram showing examples of keyword type conversion stored in a keyword conversion DB according to Embodiment 2.

FIG. 44 is a diagram showing examples of selection of demand point candidates from the degree of demand and the degree of association according to Embodiment 2.

FIG. 45 is a diagram showing examples of results obtained by executing matching process steps for a user terminal A according to Embodiment 2.

FIG. 46 is a diagram showing examples of results obtained by executing matching process steps for a user terminal B according to Embodiment 2.

FIG. 47 is a flow chart showing the flow of catch phrase generation process steps performed in the catch phrase generation device according to Embodiment 2.

FIG. 48 is a diagram showing an example of catch phrase selection for the user terminal A according to Embodiment 2.

FIG. 49 is a diagram showing an example of catch phrase selection for the user terminal B according to Embodiment 2.

FIG. 50 is a diagram showing an example of a computer system for executing a catch phrase generation program.

### DESCRIPTION OF EMBODIMENTS

Hereinafter, embodiments of catch phrase generation devices and catch phrase generation programs according to techniques of the present invention will be described in detail with reference to the accompanied drawings. It should be noted that hereinafter, the general outlines and features of the catch phrase generation devices according to the present embodiments, and the configurations and process flows of the catch phrase generation devices will be sequentially described, and in the end, various modifications to the present embodiments will be described.

### Embodiment 1

### General Outline and Features of Catch Phrase Generation Device

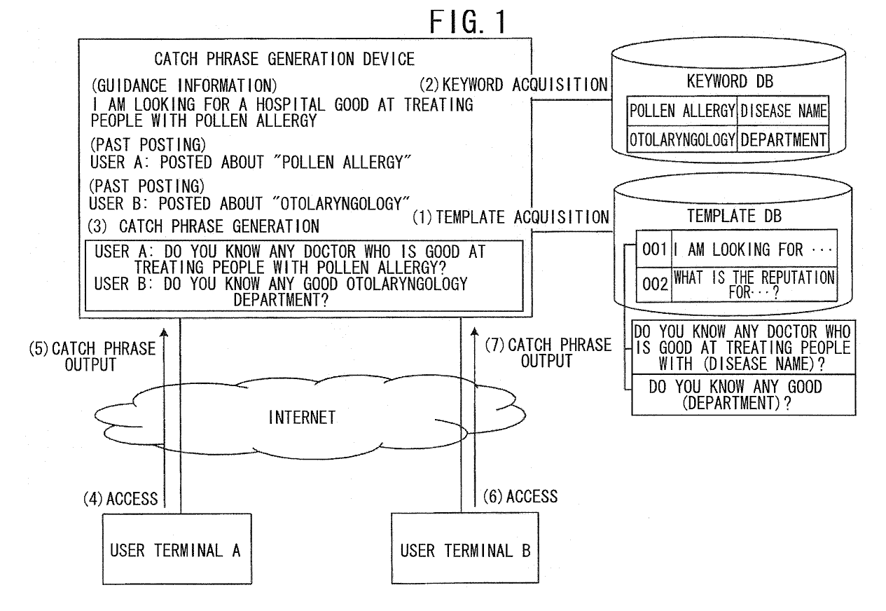

First, referring to FIG. 1, the general outline and features of the catch phrase generation device according to Embodiment 1 will be described. FIG. 1 is a system configuration diagram showing an overall configuration of a system including the catch phrase generation device according to Embodiment 1.

As shown in FIG. 1, this system includes: the catch phrase generation device for generating a catch phrase from guidance information, which is information desired to be sent to distribution destination devices; and user terminals A and B each serving as the distribution destination device for the catch phrase. The catch phrase generation device and the user terminals A and B are communicably connected to each other via a network such as the Internet.

Further, this catch phrase generation device receives access from the user terminal A, the user terminal B and the like to sell various products, and/or operate and manage a question and answer bulletin board on the Internet. In Embodiment 1, an example, in which guidance information “I am looking for a hospital good at treating people with pollen allergy.” is converted into a content suitable for a user and presented to the user, will be described based on the catch phrase generation device that operates the question and answer bulletin board on the Internet.

Furthermore, this catch phrase generation device that operates and manages the question and answer bulletin board on the Internet retains an access history database (DB) (hereinafter, also referred to as an “action history DB”) that stores “past posting” which is information posted on the bulletin board from the user terminal A and/or the user terminal B. A specific example is given as follows. This access history DB stores, for each user (person who performs an action), a date at which information is posted on the bulletin board, and a natural language extracted from a posted content; for example, as an action history of the user terminal A (performer A), “date, hospital name, department, and disease name” is stored as follows: “2007/03/30, A hospital, −, and pollen allergy” and/or “2007/01/18, A hospital, −, and gastric ulcer”.

In such a configuration, the general outline of the catch phrase generation device according to Embodiment 1 is as follows: The catch phrase generation device generates a catch phrase from guidance information to be provided to a user, and outputs the generated catch phrase to the user. In particular, the main features of the catch phrase generation device are the ability to respond to a change in preferences and/or interest of a user while preventing cost increase, and the ability to reduce burdens imposed on a distributor. In other words, the catch phrase generation device can convert guidance information “I am looking for a hospital good at treating people with pollen allergy.” into contents suitable for the user terminals A and B to present the converted contents to the user terminals A and B, respectively; as a result, the catch phrase generation device has the main features which are the ability to respond to a change in preferences and/or interest of a user while preventing cost increase, and the ability to reduce burdens imposed on a distributor.

These main features will be described more specifically below. The catch phrase generation device retains a keyword DB for storing, in association with each other, a plurality of keywords each indicating a characteristic of a user, and a property to which each of the plurality of keywords belongs. A specific example is given as follows. The catch phrase generation device retains the keyword DB that stores, for example, “pollen allergy (disease name)”, “internal medicine (department)” and “A hospital (hospital name)” as “a ‘keyword’ indicating a characteristic of a user, and a ‘type’ indicating a property to which the keyword belongs”.

Furthermore, the catch phrase generation device retains a template DB that stores a plurality of templates each having an insertion section for which a keyword property that should be inserted is determined in advance. A specific example is given as follows. The catch phrase generation device retains a template DB that stores, in association with “an ‘application condition’ indicating a template application condition”, a plurality of templates each having an insertion section. For example, the template DB stores, in association with “application condition=I am looking for . . . (ID=001)”, a template “Do you know any doctor who is good at treating people with (disease name)?” having “disease name” as an insertion section and/or a template “Do you know any good (department)?” having “department” as an insertion section. And the template DB also similarly stores a plurality of templates in association with “application condition=what is the reputation for . . . (ID=002)”.

In such a state, the catch phrase generation device selects a template corresponding to guidance information from the template DB based on a predetermined condition (see (1) of FIG. 1). A specific example is given as follows. Upon input of guidance information “I am looking for a hospital good at treating people with pollen allergy.” from a manager or the like of a bulletin board, the catch phrase generation device selects, as templates corresponding to the guidance information, “Do you know any doctor who is good at treating people with (disease name)?” and “Do you know any good (department)?”, which are templates associated with “ID=001”, from the template DB because the guidance information is in the form of “I am looking for . . . .”.

Subsequently, the catch phrase generation device analyzes a history of access which has been created by the user or to which reference has been made by the user, and acquires, based on the analyzed result, a keyword stored in the keyword DB (see (2) of FIG. 1). A specific example is given as follows. Since among information previously posted from the user terminal A, “pollen allergy” exists in the access history DB and “pollen allergy” associated with “type=disease name” also exists in the keyword DB, the catch phrase generation device acquires “pollen allergy (disease name)” as a receiver characteristic expression (keyword) indicating a characteristic of the user terminal A. On the other hand, since among information previously posted from the user terminal B, “otolaryngology” exists in the access history DB and “otolaryngology” associated with “type=department” exists in the keyword DB although a “keyword” of “type=disease name” does not exist for the user terminal B, the catch phrase generation device acquires “otolaryngology (department)” as a keyword indicating a receiver characteristic of the user terminal B. In other words, for the user terminal A, the catch phrase generation device acquires, as a receiver characteristic expression (keyword), “pollen allergy (disease name)” stored in both of the action history DB and the keyword DB, and for the user terminal B, the catch phrase generation device similarly acquires “otolaryngology (department)” as a receiver characteristic expression (keyword).

Further, from among the acquired keywords each indicating the receiver characteristic, the catch phrase generation device selects the receiver characteristic expression (keyword) belonging to a property identical to the property determined for an insertion section of the template selected from the template DB, and inserts the receiver characteristic expression into the insertion section of the template, thereby generating a catch phrase (see (3) of FIG. 1). Based on the above-described example, specific description will be given as follows. The acquired keyword is “pollen allergy (disease name)” for the user terminal A; therefore, from “Do you know any doctor who is good at treating people with (disease name)?” and “Do you know any good (department)?” which are templates associated with “ID=001”, the catch phrase generation device selects “Do you know any doctor who is good at treating people with (disease name)?” which is a template having (disease name) as an insertion section. Then, the catch phrase generation device inserts the acquired keyword “pollen allergy” into the template “Do you know any doctor who is good at treating people with (disease name)?”, thereby generating a catch phrase “Do you know any doctor who is good at treating people with pollen allergy?”.

In a like manner, for the user terminal B, the acquired keyword indicating the receiver characteristic is “otolaryngology (department)”; therefore, from “Do you know any doctor who is good at treating people with (disease name)?” and “Do you know any good (department)?” which are templates associated with “ID=001”, the catch phrase generation device selects “Do you know any good (department)?” which is a template having (department) as an insertion section. Then, the catch phrase generation device inserts the acquired keyword “otolaryngology” into the template “Do you know any good (department)?”, thereby generating a catch phrase “Do you know any good otolaryngology department?”.

Thereafter, upon receipt of access to the bulletin board from the user terminal A (see (4) of FIG. 1), the catch phrase generation device outputs “Do you know any doctor who is good at treating people with pollen allergy?” suitable for the user terminal A among the generated catch phrases (see (5) of FIG. 1). Upon receipt of access to the bulletin board from the user terminal B (see (6) of FIG. 1), the catch phrase generation device outputs “Do you know any good otolaryngology department?” suitable for the user terminal B among the generated catch phrases (see (7) of FIG. 1). It should be noted that the terminal, which has made access to the bulletin board, may be determined as the user terminal A or the user terminal B by a conventional method in which the terminal is determined based on an IP address and/or a user ID.

Thus, the catch phrase generation device according to Embodiment 1 can acquire, as a keyword, a natural language stored in both the action history DB and the keyword DB, and can automatically generate a catch phrase suitable for the distribution destination device, resulting in the main features as described above, which are the ability to respond to a change in preferences and/or interest of a user while preventing cost increase, and the ability to reduce burdens imposed on a distributor.

<Configuration of Catch Phrase Generation Device>

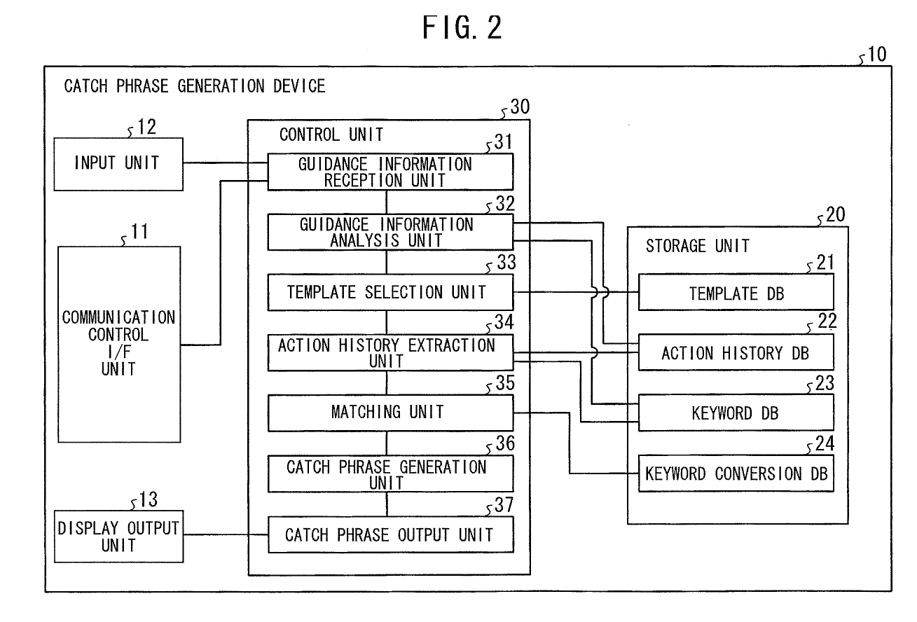

Next, referring to FIG. 2, a configuration of the catch phrase generation device shown in FIG. 1 will be described. FIG. 2 is a block diagram showing a configuration of the catch phrase generation device according to Embodiment 1. As shown in FIG. 2, this catch phrase generation device 10 includes: a communication control I/F unit 11; an input unit 12; a display output unit 13; a storage unit 20; and a control unit 30. Each functional unit in the control unit 30 will be described in detail when describing the after-mentioned process flow, and therefore, the general outline of each functional section will be described below.

The communication control I/F unit 11 controls communication concerning various pieces of information exchanged with the user terminal A and/or the user terminal B connected via a network such as the Internet. Specifically, upon receipt of a content posted on a bulletin board, the communication control I/F section 11, for example, outputs the received content to the display output unit 13 described later.

The input unit 12 is configured to include, a keyboard, a mouse, and/or a microphone, and receives input of various pieces of information. For example, the input unit 12 receives a catch phrase generation start instruction from a manager and/or an operator who manage(s) the catch phrase generation device 10. The display output unit 13 is configured to include a monitor (or a display and/or a touch panel), and/or a speaker, and outputs various pieces of information. For example, the display output unit 13 outputs a bulletin board and/or a catch phrase, and outputs a content that is received by the communication control I/F unit 11 and to be posted on the bulletin board.

The storage unit 20 stores data and programs which are necessary for various processes performed by the control unit 30, and in close connection with the present invention in particular, the storage unit 20 includes a template storage database (DB) 21, an action history DB 22, a keyword storage DB 23 and a keyword conversion storage DB 24.

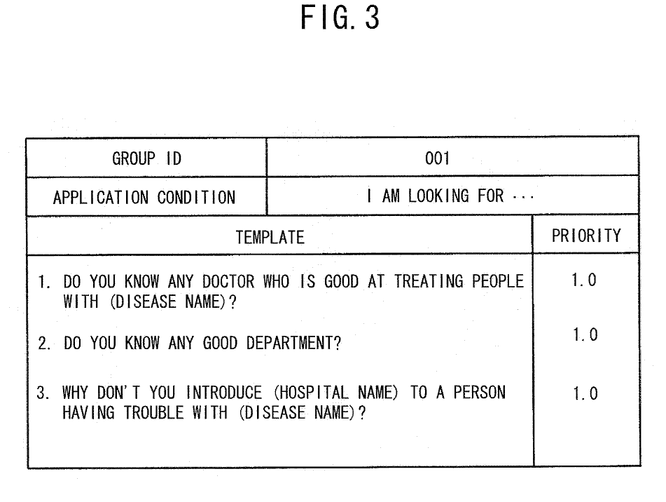

The template DB 21 stores, in a grouped manner, a plurality of templates each having an insertion section for which a keyword property that should be inserted is determined in advance. A specific example is given as follows. As shown in FIG. 3, the template DB 21 stores, in association with “group ID=001, application condition=‘I am looking for . . . .’”, a template having “disease name” as an insertion section “Do you know any doctor who is good at treating people with (disease name)?”, a template having “department” as an insertion section “Do you know any good (department)?”, and a template having “disease name” and “hospital name” as insertion sections “Why don't you introduce (hospital name) to a person having trouble with (disease name)?”, for example. Information including various pieces of data and parameters can be freely changed unless otherwise specified. Further, the template DB 21 corresponds to “template storage unit” recited in the claims. Furthermore, FIG. 3 is a diagram showing exemplary information stored in the template DB.

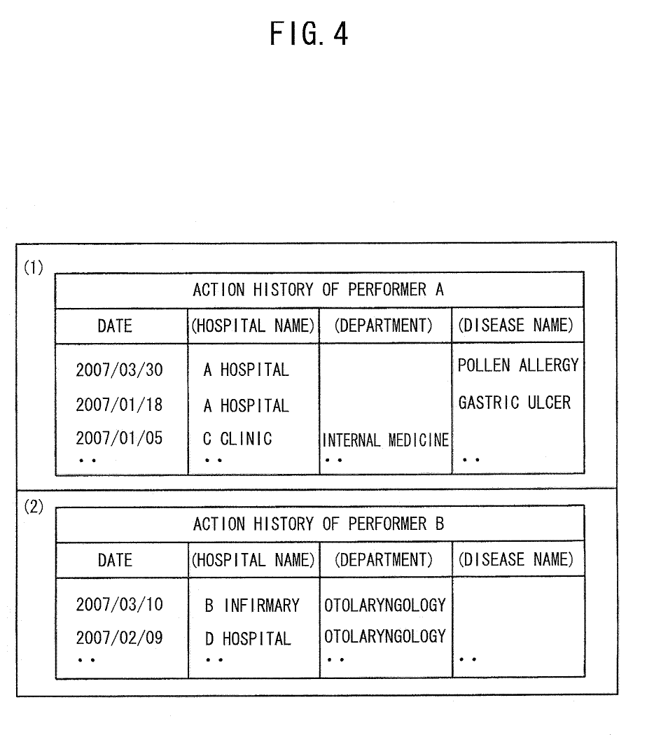

The action history DB 22 stores, for each distribution destination device, a keyword extracted from the past access history of the distribution destination device. A specific example is given as follows. As shown in FIG. 4, for each of the performer A (user terminal A) and the performer B (user terminal B), the action history DB 22 stores, for example, “2007/3/30, A hospital, −, and pollen allergy” as “‘date’ at which access was received, and ‘hospital name’, ‘department’ and ‘disease name’ which are objects to be extracted from an access history”. Information including various pieces of data and parameters can be freely changed unless otherwise specified. Further, FIG. 4 is a diagram showing exemplary information stored in the action history DB.

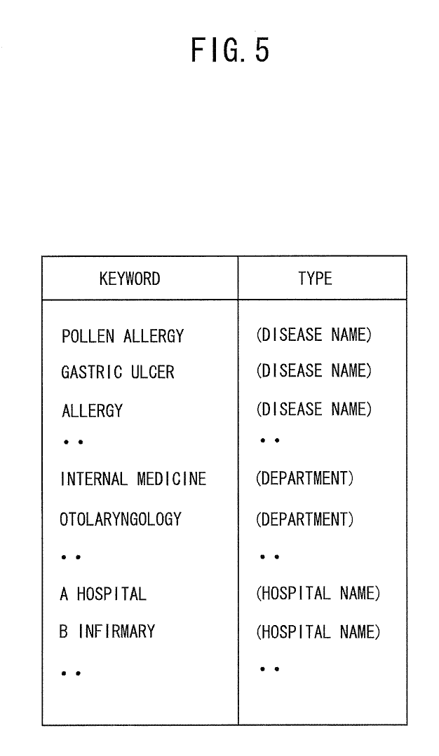

The keyword DB 23 stores, in association with each other, a plurality of keywords each indicating a characteristic of a user, and a property to which each of the plurality of keywords belongs. A specific example is given as follows. As shown in FIG. 5, the keyword DB 23 stores, for example, “pollen allergy (disease name)”, “internal medicine (department)” and “A hospital (hospital name)” as “‘keywords’ indicating characteristics of a user, and ‘types’ indicating properties to which the keywords belongs”. Information including various pieces of data and parameters can be freely changed unless otherwise specified. Further, the keyword DB 23 corresponds to “keyword storage unit” recited in the claims. Furthermore, FIG. 5 is a diagram showing exemplary information stored in the keyword DB.

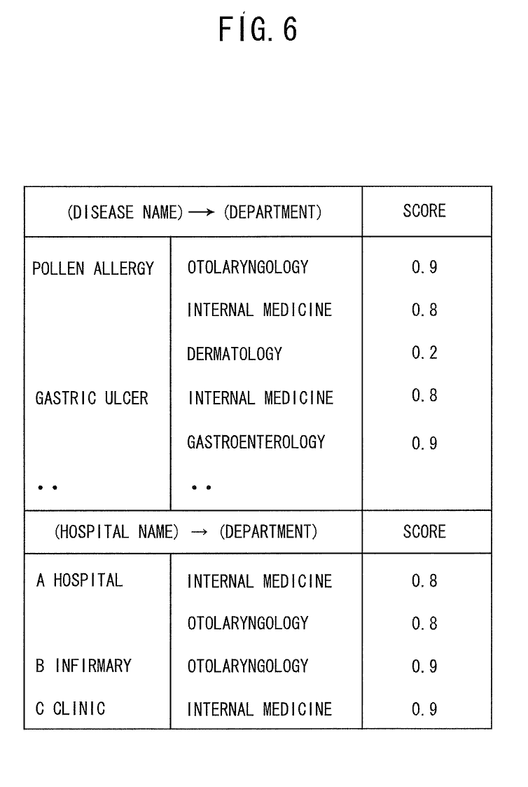

The keyword conversion DB 24 stores, in association with a keyword, a conversion keyword belonging to a property having a meaning associated with the keyword and different from the property of the keyword, and the degree of association between the keyword and the conversion keyword. A specific example is given as follows. As shown in FIG. 6, the keyword conversion DB 24 stores “properties to be converted” and “scores indicating the degree of association” in association with each other. For example, when “properties to be converted” are “from disease name to department”, the keyword conversion DB 24 stores “pollen allergy, otolaryngology, and 0.9”, and when “properties to be converted” are “from hospital name to department”, the keyword conversion DB 24 stores “A hospital, internal medicine, and 0.8”. Information including various pieces of data and parameters can be freely changed unless otherwise specified. Further, the keyword conversion DB 24 corresponds to “conversion keyword storage unit” recited in the claims. Furthermore, FIG. 6 is a diagram showing exemplary information stored in the keyword conversion DB.

The control unit 30 has an internal memory for storing a control program of an OS (operating system) or the like, and programs and necessary data that specify various process procedures, for example. And in close connection with the present invention in particular, the control unit 30 includes: a guidance information reception unit 31; a guidance information analysis section 32; a template selection unit 33; an action history extraction section 34; a matching unit 35; a catch phrase generation unit 36; and a catch phrase output section 37. The control unit 30 executes various process steps with these sections.

The guidance information reception unit 31 receives guidance information from a manager or the like via the communication control I/F section 11 and/or the input unit 12. A specific example is given as follows. The guidance information reception unit 31 receives guidance information “I am looking for a hospital good at treating people with pollen allergy.” inputted from a manager or the like via the communication control I/F unit 11 and/or the input unit 12, and outputs the received guidance information to the guidance information analysis unit 32 described below.

The guidance information analysis unit 32 segments the inputted guidance information into words, and when the segmented words are stored in the keyword DB 23, the guidance information analysis unit 32 acquires these words and properties as guidance points. A specific example is given as follows. Upon receipt of guidance information from the guidance information reception unit 31, the guidance information analysis unit 32 performs morphological analysis and word segmentation on the received guidance information, and when the segmented words are stored in the keyword DB, the guidance information analysis unit 32 acquires the stored words as guidance points indicating a characteristic of a user. The guidance information analysis unit 32 corresponds to “guidance point acquisition unit” recited in the claims.

From the template DB 21 that unit, in association with each other, a plurality of keywords each indicating a characteristic of a user and a property to which each of the plurality of keywords belongs, the template selection unit 33 selects a group of templates corresponding to the guidance information based on a predetermined condition. A specific example is given as follows. For the guidance information “I am looking for a hospital good at treating people with pollen allergy”, the template selection unit 33 selects a group of templates with the identical application condition from the template DB 21. The template selection unit 33 corresponds to “template selection unit” recited in the claims.

The action history extraction unit 34 analyzes a history of access which has been created by a user or to which reference has been made by the user, and acquires, based on the analyzed result, a keyword stored in the keyword DB 23. A specific example is given as follows. The action history extraction unit 34 performs morphological analysis and word segmentation on an access history in which actions (posting and/or browsing) performed by a receiver (distribution destination device) without awareness of catch phrase generation are stored. Then, the action history extraction unit 34 acquires, as a keyword indicating a receiver characteristic, the word stored in the keyword DB 23 among the segmented words, and stores the acquired word in the action history DB 22. The action history extraction unit 34 corresponds to “keyword acquisition unit” recited in the claims.

The matching unit 35 inserts the keyword, acquired by the action history extraction unit 34 and indicating a receiver characteristic, into the template acquired by the template selection unit 33, and calculates the “degree of demand” as a first association value based on the degree (score) of association of the inserted keyword or conversion keyword, and the timing of the analyzed access history. In addition, the matching unit 35 calculates the “degree of association” as a second association value based on the degree of association of the inserted keyword or conversion keyword, and a guidance point acquired by the guidance information analysis unit 32. Specifically, from the receiver characteristic expressions and guidance points acquired from the action history, the matching unit 35 searches for information that should fill the template, and detects information, which is appropriate to the intention of guidance of the distribution destination device and to which a receiver is likely to react, by using the “degree of demand” and the “degree of association”.

The catch phrase generation unit 36 selects a catch phrase from a plurality of templates by further using the first association value and the second association value calculated by the matching unit 35. A specific example is given as follows. From among the templates into which keywords are inserted, the catch phrase generation unit 36 selects, as a catch phrase, the template having the largest first association value “degree of demand” and the largest second association value “degree of association”, which are calculated by the matching section 35. The matching unit 35 and the catch phrase generation unit 36 correspond to “catch phrase generation unit” recited in the claims.

Upon receipt of access from a user terminal, the catch phrase output unit 37 outputs the catch phrase, suitable for the user terminal and selected by the catch phrase generation unit 36, to the display output unit 13 so that the catch phrase is displayed thereon.

<Process Steps Performed by Catch Phrase Generation Device>

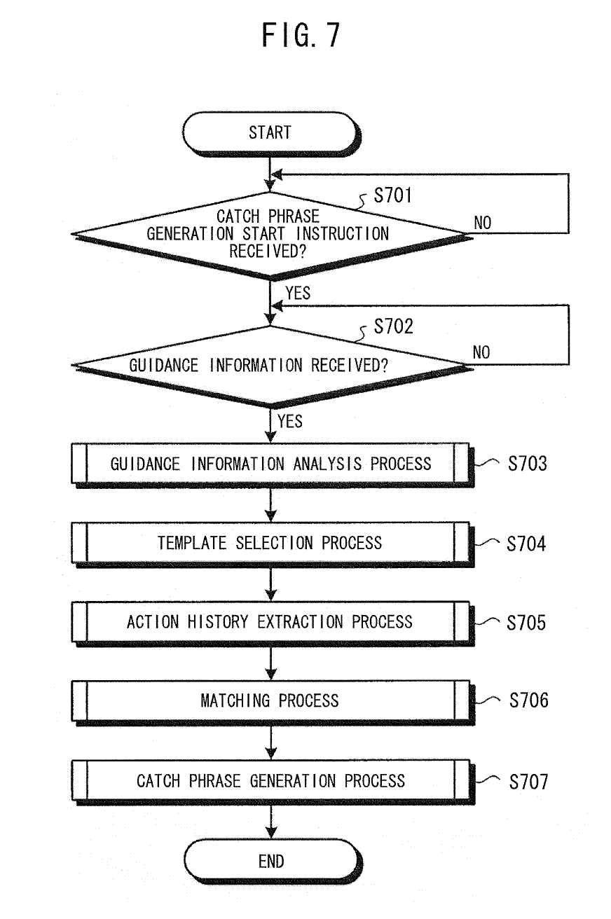

Next, referring to FIG. 7, process steps performed by the catch phrase generation device will be described. FIG. 7 is a flow chart showing the flow of overall process steps performed in the catch phrase generation device according to Embodiment 1. It should be noted that, referring to FIG. 7, only the flow of overall process steps performed in the catch phrase generation device 10 will be described, and the detailed description thereof will be made later.

—Flow of Overall Process Steps—

As shown in FIG. 7, upon receipt of a catch phrase generation start instruction from a manager or the like (i.e., when the answer is Yes in Step S701) and receipt of guidance information (i.e., when the answer is Yes in Step S702) by the guidance information reception unit 31, the guidance information analysis section 32 of the catch phrase generation device 10 performs a guidance information analysis process for segmenting the inputted guidance information into words, and for acquiring, when the segmented words are stored in the keyword DB 23, these words and properties as guidance points; then, at the end of the process, the guidance information analysis unit 32 notifies the template selection unit 33 about this (Step S703).

Then, upon notification of the end of the guidance information analysis process, the template selection unit 33 of the catch phrase generation device 10 performs a template selection process for selecting, based on a predetermined condition, a group of templates corresponding to the guidance information from the template DB 21 that stores, in association with each other, a plurality of keywords each indicating a characteristic of a user, and a property to which each of the plurality of keywords belongs; then, upon end of the process, the template selection unit 33 notifies the action history extraction unit 34 about this (Step S704).

Then, upon notification of the end of the template selection process, the action history extraction unit 34 of the catch phrase generation device 10 performs an action history extraction process for analyzing an access history which has been created by a user or to which reference has been made by the user, and for acquiring, based on the analyzed result, a keyword stored in the keyword DB 23; then, at the end of the process, the action history extraction unit 34 notifies the matching unit 35 about this (Step S705).

Upon notification of the end of the action history extraction process, the matching unit 35 of the catch phrase generation device 10 performs a matching process for inserting the acquired keyword into each of the selected templates, and for calculating the “degree of demand” as the first association value and the “degree of association” as the second association value; then, at the end of the process, the matching unit 35 notifies the catch phrase generation unit 36 about this (Step S706).

Then, upon notification of the end of the matching process, the catch phrase generation unit 36 of the catch phrase generation device 10 performs a catchphrase generation process for selecting a catch phrase from a plurality of templates by further using the first association value and the second association value, which are calculated by the matching unit 35 (Step S707). Thereafter, upon receipt of access from a user terminal, the catch phrase output unit 37 of the catch phrase generation device 10 outputs a catch phrase suitable for the received user terminal.

—Flow of Guidance Information Analysis Process Steps—

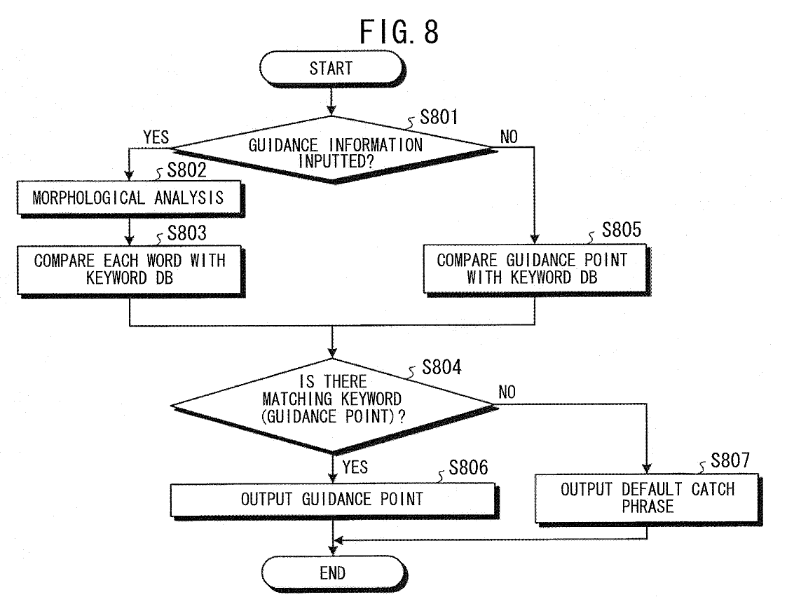

Next, referring to FIG. 8, guidance information analysis process steps performed by the catch phrase generation device will be described. FIG. 8 is a flow chart showing the flow of guidance information analysis process steps performed in the catch phrase generation device according to Embodiment 1. As shown in FIG. 8, the guidance information analysis unit 32 of the catch phrase generation device 10 determines whether or not the inputted information is guidance information (Step S801).

Then, when the inputted information is guidance information (i.e., when the answer is Yes in Step S801), the guidance information analysis unit 32 performs morphological analysis and word segmentation on the inputted guidance information (Step S802), and makes a comparison between each segmented word and the keyword DB 23 (Step S803). When there is a matching keyword (i.e., when the answer is Yes in Step S804), the guidance information analysis unit 32 outputs, as a guidance point, the keyword to the matching unit 35, and notifies the catch phrase output unit 37 that the process has ended (Step S806).

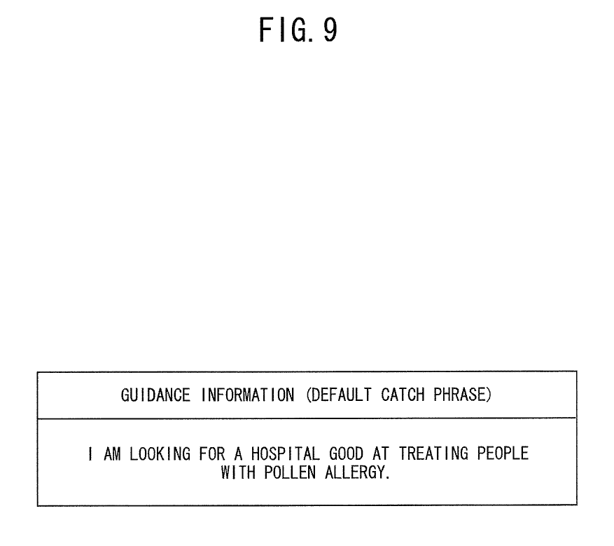

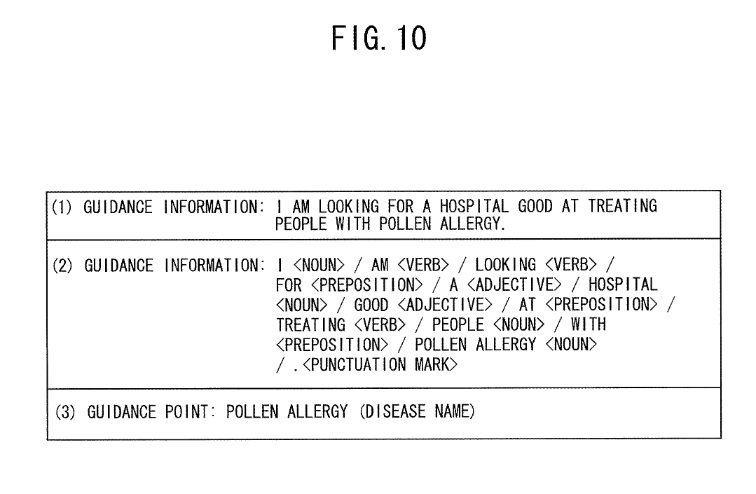

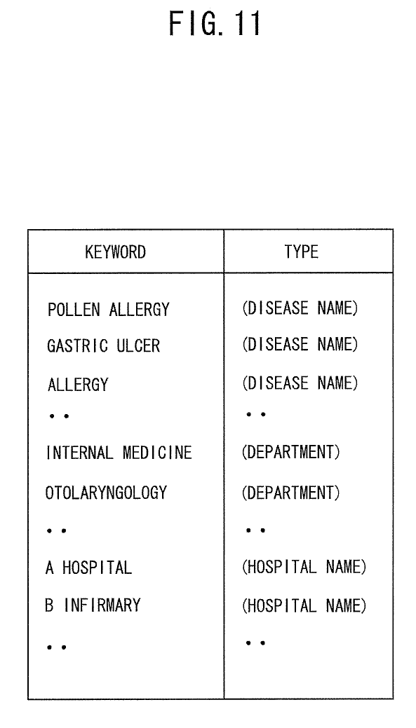

A specific example is given as follows. Upon input of guidance information shown in FIG. 9, the guidance information analysis unit 32 performs morphological analysis and word segmentation on the inputted guidance information to determine parts of speech as shown in FIG. 10-(2). And among the segmented words, the guidance information analysis unit 32 outputs, as guidance points, the words “pollen allergy”, shown in FIG. 11 and stored in the keyword DB 23, to the matching unit 35. It should be noted that FIG. 9 is a diagram showing exemplary guidance information, FIG. 10 is a diagram showing an example of morphological analysis, and FIG. 11 is a diagram showing exemplary information stored in the keyword DB.

On the other hand, when there is no matching keyword (i.e., when the answer is No in Step S804), the guidance information analysis unit 32 outputs, as a default catch phrase, the inputted guidance information to the catch phrase output unit 37, and notifies the catch phrase output unit 37 that the process has ended (Step S807).

Returning to Step S801, when the inputted information is not guidance information, i.e., when the prespecified guidance point candidate, default catch phrase and/or application condition are/is inputted by a manager (i.e., when the answer is No in Step S801), the guidance information analysis unit 32 makes a comparison between the inputted guidance point candidate and the keyword DB 23 (Step S805). When there is a matching keyword (i.e., when the answer is Yes in Step S804), the guidance information analysis unit 32 outputs, as a guidance point, the keyword to the matching unit 35 (Step S806). When there is no matching keyword (i.e., when the answer is No in Step S804), the guidance information analysis unit 32 outputs the inputted default catch phrase to the catch phrase output unit 37, and notifies the catch phrase output unit 37 that the process has ended (Step S807).

—Flow of Template Selection Process Steps—

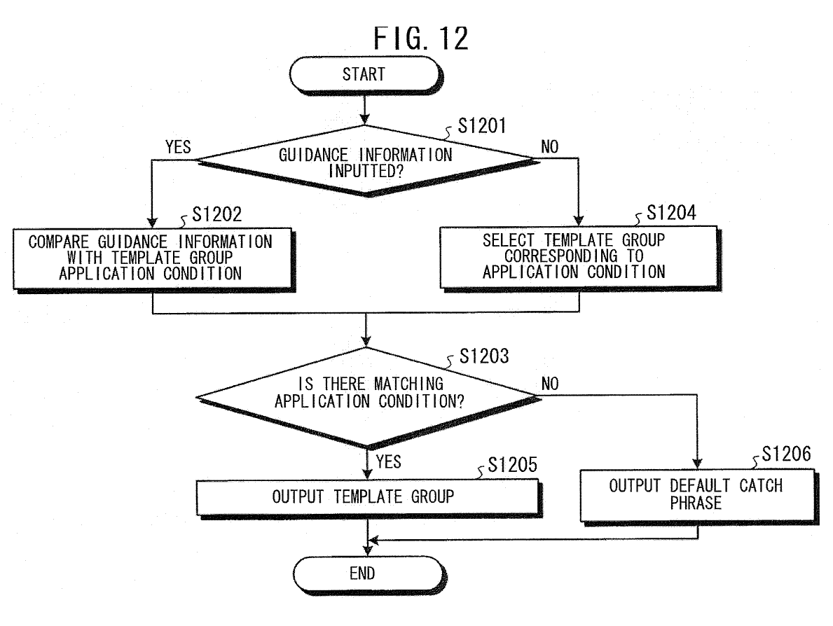

Next, referring to FIG. 12, template selection process steps performed by the catch phrase generation device will be described. FIG. 12 is a flow chart showing the flow of template selection process steps performed in the catch phrase generation device according to Embodiment 1.

As shown in FIG. 12, the template selection unit 33 of the catch phrase generation device 10, which has received a notification that the guidance information analysis process has ended, determines whether or not the inputted information is guidance information (Step S1201).

Then, when the inputted information is guidance information (i.e., when the answer is Yes in Step S1201), the template selection unit 33 makes a comparison between the inputted guidance information and application conditions of template groups stored in the template DB 21 (Step S1202). When there is a matching application condition (i.e., when the answer is Yes in Step S1203), the template selection unit 33 outputs the template group corresponding to the application condition to the matching unit 35, and notifies the action history extraction unit 34 that the process has ended (Step S1205).

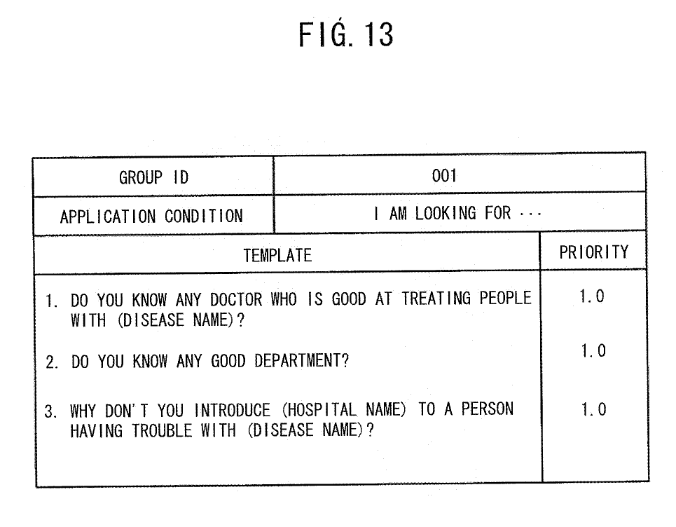

Based on the above-described example, specific description will be given as follows. Upon input of the guidance information “I am looking for a hospital good at treating people with pollen allergy.”, the template selection unit 33 selects, from the template DB 21, a template group (group ID=001) which is shown in FIG. 13 and the application condition of which is identical to the inputted guidance information “I am looking for . . . .”, and outputs the selected template group (group ID=001) to the matching unit 35. FIG. 13 is a diagram showing an example of the template group.

On the other hand, when there is no matching application condition (i.e., when the answer is No in Step S1203), the template selection unit 33 outputs, as a default catch phrase, the inputted guidance information to the catch phrase output unit 37, and notifies the action history extraction unit 34 that the process has ended (Step S1206).

Returning to Step S1201, when the inputted information is not guidance information, i.e., when the prespecified guidance point candidate, default catch phrase and/or application condition are/is inputted by a manager (i.e., when the answer is No in Step S1201), the template selection unit 33 makes a comparison between the inputted application condition and the application conditions of the templates stored in the template DB 21 (Step S1204). When there is a matching application condition (i.e., when the answer is Yes in Step S1203), the template selection unit 33 outputs the template group corresponding to the application condition to the matching unit 35 (Step S1205). When there is no matching application condition (i.e., when the answer is No in Step S1203), the template selection unit 33 outputs the default catch phrase, which has been inputted to the guidance information analysis unit 32, to the catch phrase output unit 37, and notifies the action history extraction unit 34 that the process has ended (Step S1206).

—Flow of Action History Extraction Process Steps—

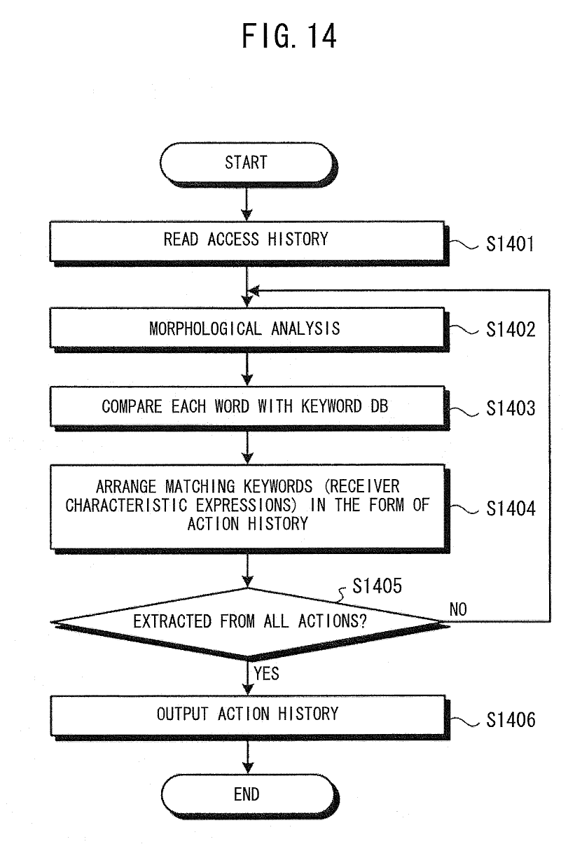

Next, referring to FIG. 14, action history extraction process steps performed by the catch phrase generation device will be described. FIG. 14 is a flow chart showing the flow of action history extraction process steps performed in the catch phrase generation device according to Embodiment 1.

As shown in FIG. 14, the action history extraction unit 34 of the catch phrase generation device 10, which has received a notification that the template selection process has ended, reads an access history (Step S1401), performs morphological analysis and word segmentation on the read access history to determine parts of speech (Step S1402), makes a comparison between each segmented word and each keyword stored in the keyword DB 23 (Step S1403), and arranges matching keywords in the form of an action history (Step S1404).

Then, when the foregoing process steps of Step S1402 to Step S1404 have been executed on all the access histories (i.e., when the answer is Yes in Step S1405), the action history extraction unit 34 outputs the action history, which has been created at Step S1404, to the action history DB 22, and notifies the matching unit 35 that the process has ended (Step S1406). When the foregoing process steps of Step S1402 to Step S1404 have not been executed on all the access histories (i.e., when the answer is No in Step S1405), the process is returned to Step S1402, and the process steps of Step S1402 to Step S1405 are executed.

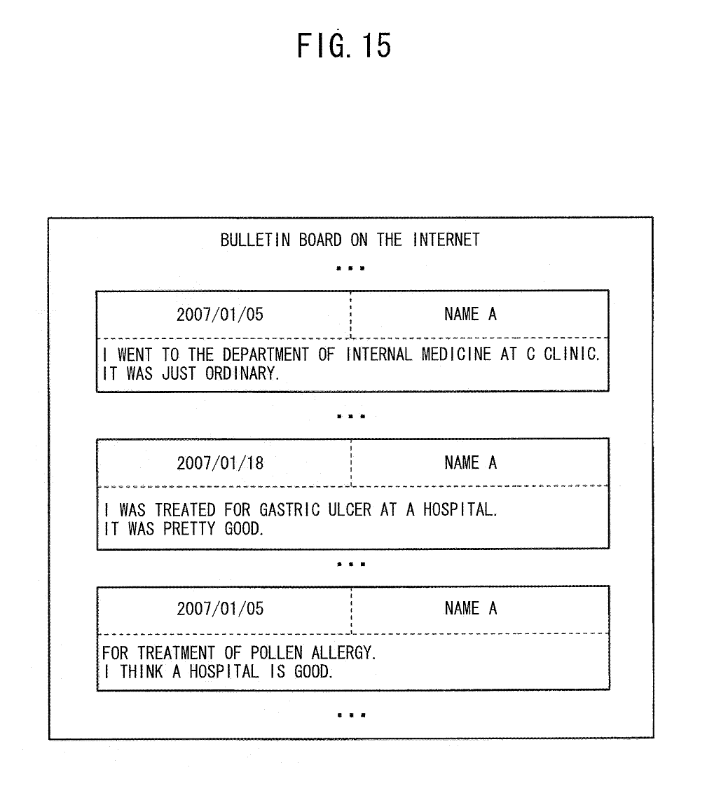

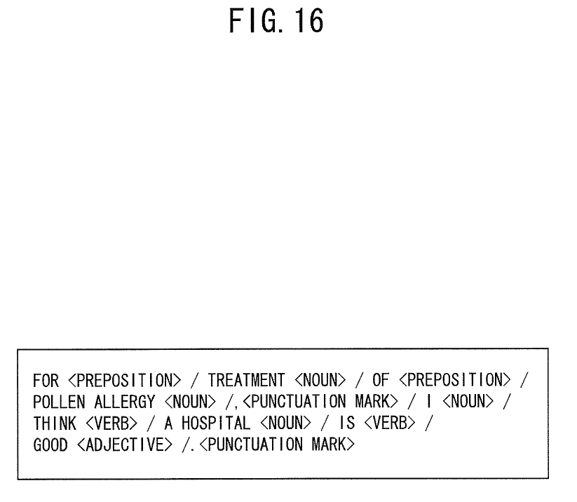

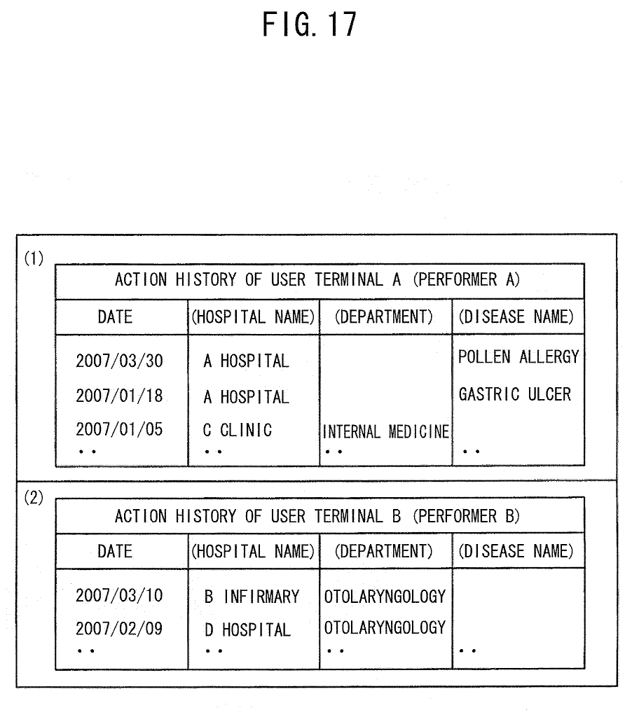

More specifically, the action history extraction unit 34 of the catch phrase generation device 10, which has received a notification that the template selection process has ended, reads an access history of bulletin board posting shown in FIG. 15, performs morphological analysis and word segmentation on the read access history to determine parts of speech as shown in FIG. 16, makes a comparison between each segmented word and each keyword stored in the keyword DB 23, arranges matching keywords in the form of an action history for each user terminal (performer) as shown in FIG. 17, and then outputs the action history to the action history DB 22. FIG. 15 is a diagram showing an example of the access history (bulletin board posting), FIG. 16 is a diagram showing an example of the morphological analysis, and FIG. 17 is a diagram showing examples of action history extraction results.

—Flow of Matching Process Steps—

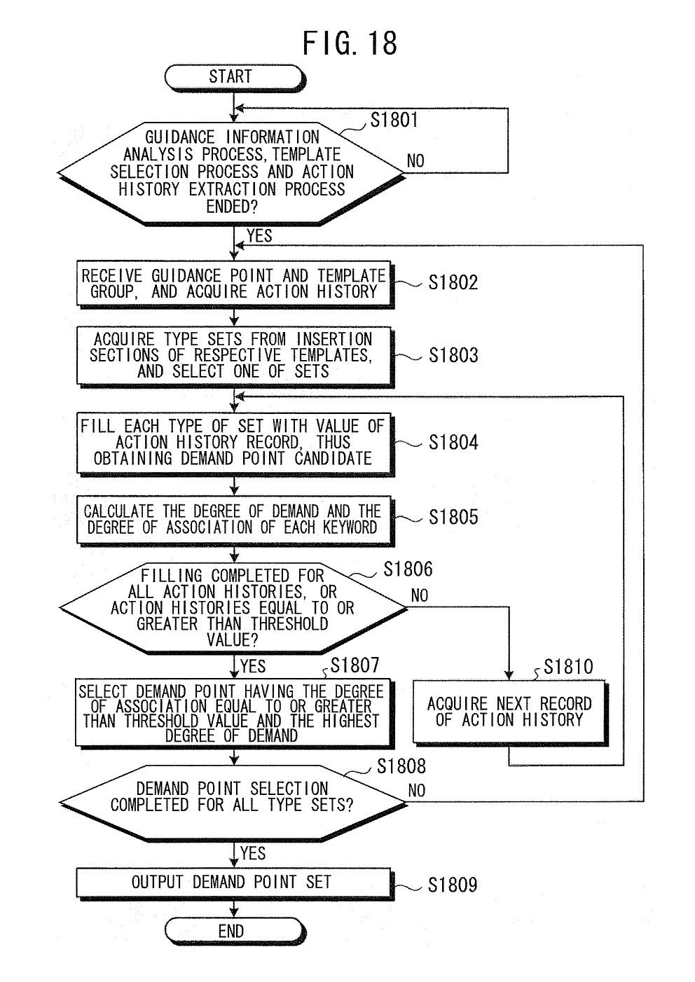

Next, referring to FIG. 18, matching process steps performed by the catch phrase generation device will be described. FIG. 18 is a flow chart showing the flow of matching process steps performed in the catch phrase generation device according to Embodiment 1.

As shown in FIG. 18, upon receipt of a notification that the guidance information analysis process, the template selection process and the action history extraction process have ended (i.e., when the answer is Yes in Step S1801), the matching unit 35 of the catch phrase generation device 10 receives the “guidance point” outputted from the guidance information analysis section 32 and the “template group” outputted from the template selection unit 33, and acquires the “action history” stored in the action history DB 22 (Step S1802).

Then, the matching unit 35 acquires, as sets, the insertion sections of respective templates of the received template group, selects one of the sets (Step S1803), and inserts values (keywords) of action history record stored in the action history DB 22 into the selected set, thus obtaining a demand point candidate (Step S1804).

Subsequently, the matching unit 35 calculates the degree of demand (“first association value” recited in claims) and the degree of association (“second association value” recited in claims) of each keyword inserted into the set (Step S1805), and determines whether or not the insertion has been completed for all the action histories, or the action histories equal to or greater than a threshold value (Step S1806). Subsequent to this, when the insertion has been completed (i.e., when the answer is Yes in Step S1806), the matching unit 35 selects a demand point having the degree of association equal to or greater than a threshold value and the highest degree of demand (Step S1807), and determines whether or not the selection of the demand point has been completed for all the sets (Step S1808). Then, when the selection of the demand point has been completed for all the sets (i.e., when the answer is Yes in Step S1808), the matching unit 35 outputs the set, into which the demand point has been inserted, to the catch phrase generation unit 36 (Step S1809).

On the other hand, when the insertion has not been completed for all the action histories, or the action histories equal to or greater than the threshold value (i.e., when the answer is No in Step S1806), the matching unit 35 acquires the next action history record stored in the action history DB 22 (Step S1810), returns the process to Step S1804, and executes the process steps of Step S1804 to Step S1806. When the selection of the demand point has not been completed for all the sets (i.e., when the answer is No in Step S1808), the matching unit 35 returns the process to Step S1802, and executes the process steps of Step S1802 to Step S1808.

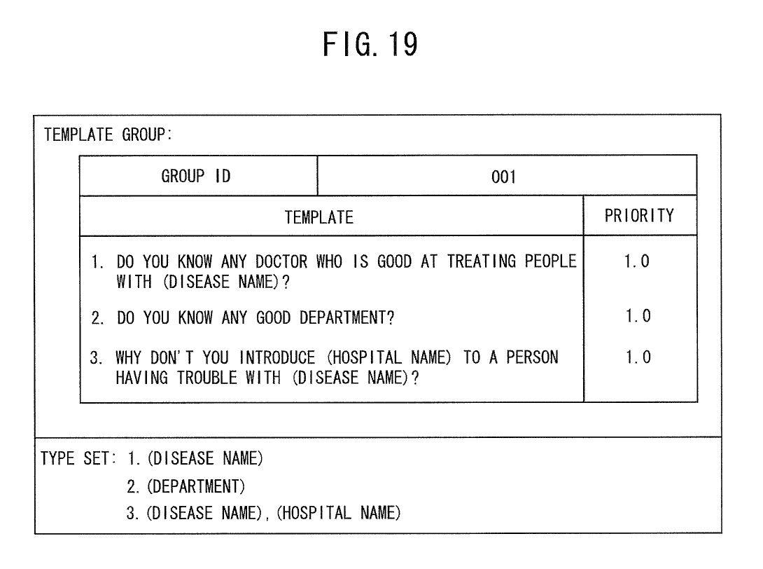

Now, the foregoing example will be more specifically described for the user terminal A with regard to Step S1801 to Step S1810. As shown in FIG. 19, the matching unit 35, which has acquired the “guidance point”, the “template group” and the “action history”, acquires, as sets, “disease name”, “department” and “disease name, hospital name” which are insertion sections of respective templates of the received template group. Then, the matching unit 35 selects one of the sets (for example, the third set “disease name, hospital name” shown in FIG. 19), and inserts keywords “A hospital, pollen allergy” of the action history record “2007/03/30, A hospital, −, pollen allergy” stored in the action history DB 22 into the selected third set, thus obtaining a demand point candidate.

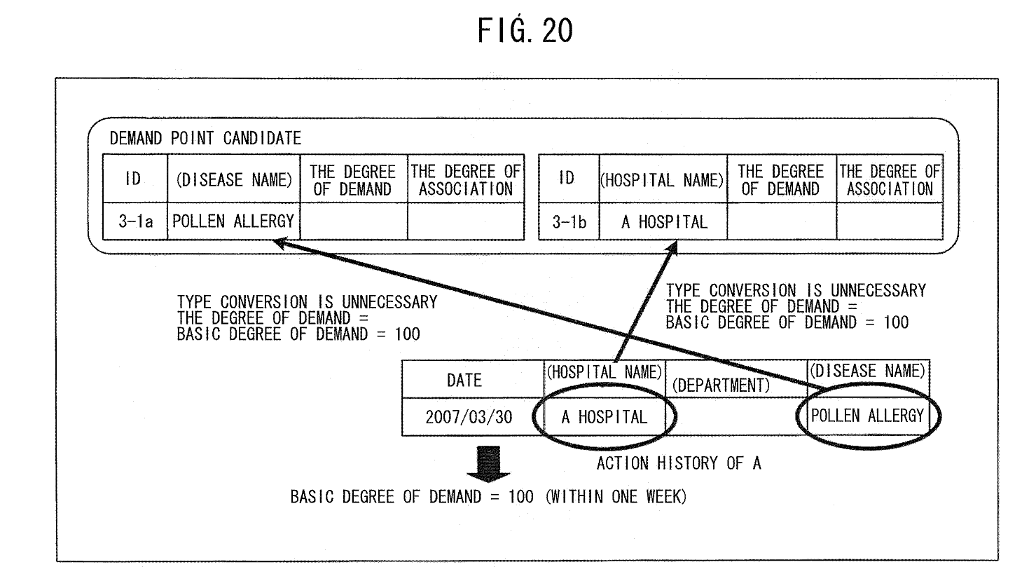

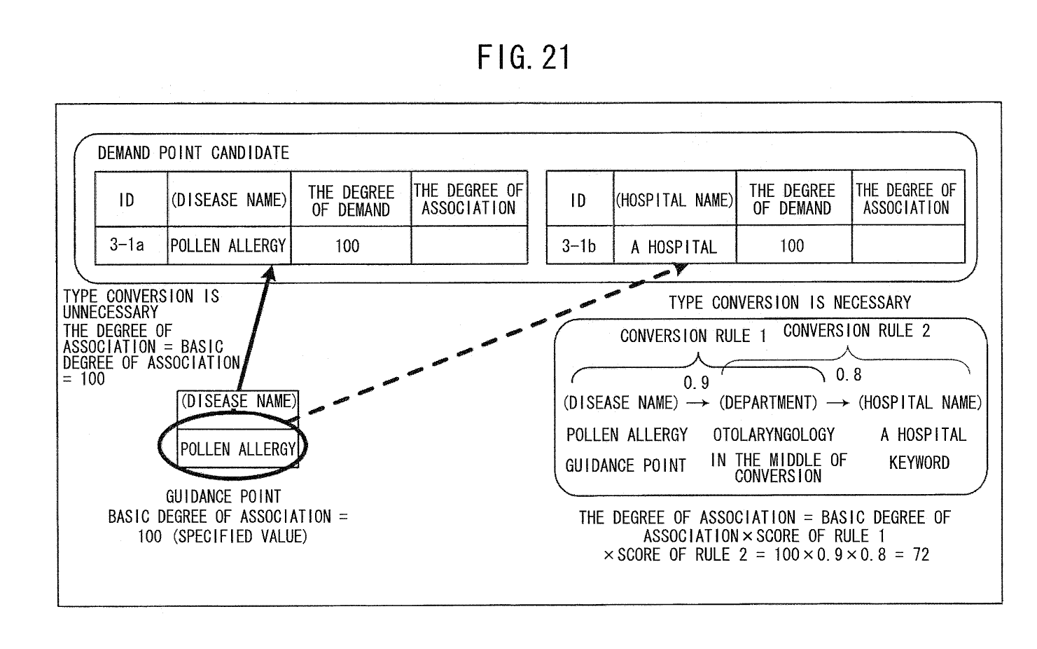

Subsequently, as shown in FIG. 20, the matching unit 35 calculates the “degree of demand” of the selected keywords “2007/03/30, A hospital, −, pollen allergy” as: “basic degree of demand=100” when the date of the selected keywords stored in the action history DB 22 is within a week of the date at which the guidance information was inputted; “basic degree of demand=90” when the date of the selected keywords stored in the action history DB 22 is within a month of the date at which the guidance information was inputted; and “basic degree of demand=80” when the date of the selected keywords stored in the action history DB 22 is within three months of the date at which the guidance information was inputted. In this case, if the date at which the guidance information was inputted is “2007/04/01”, the matching unit 35 calculates as follows: “Degree of demand=100” for the keywords “A hospital”, and “degree of demand=100” for the keyword “pollen allergy”. Subsequent to this, the matching unit 35 calculates the degree of association for each of the selected “keywords” as shown in FIG. 21. When “guidance point=pollen allergy”, acquired by the guidance information analysis process (FIGS. 8 to 11) performed by the guidance information analysis section 32, is identical to the selected “keyword”, the matching unit 35 determines the “degree of association” as “100 (basic degree of association)”. Accordingly, since the keyword “pollen allergy” is identical to the guidance point, the matching unit 35 determines the degree of association thereof as “100” which is the same as the basic degree of association.

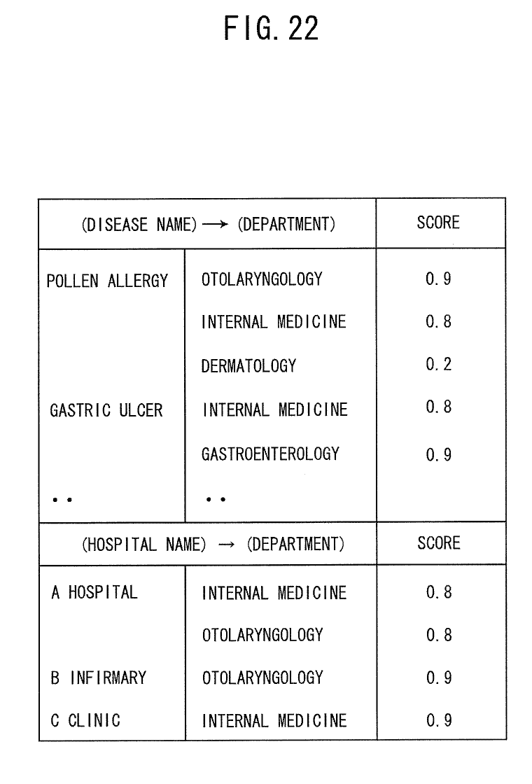

On the other hand, since “A hospital (hospital name)” is different in type from the guidance point, type conversion is necessary. To this end, the matching unit 35 uses keyword type conversion rules as shown in FIG. 21 to perform a type conversion from the guidance point “pollen allergy (disease name)” to “A hospital (hospital name)”. Thus, referring to information shown in FIG. 22 and stored in the keyword conversion DB 24, it can be seen that the matching unit 35 has “pollen allergy otolaryngology” as a conversion rule for “(disease name) (department)”, and “otolaryngology A hospital” as a conversion rule for “(department) (hospital name)”. Hence, as can be seen from FIG. 21, since the degree of association is determined by “basic degree of association×score”, the matching unit 35 calculates the degree of association of the keyword “A hospital (hospital name)” as “100×0.9×0.8=72”.

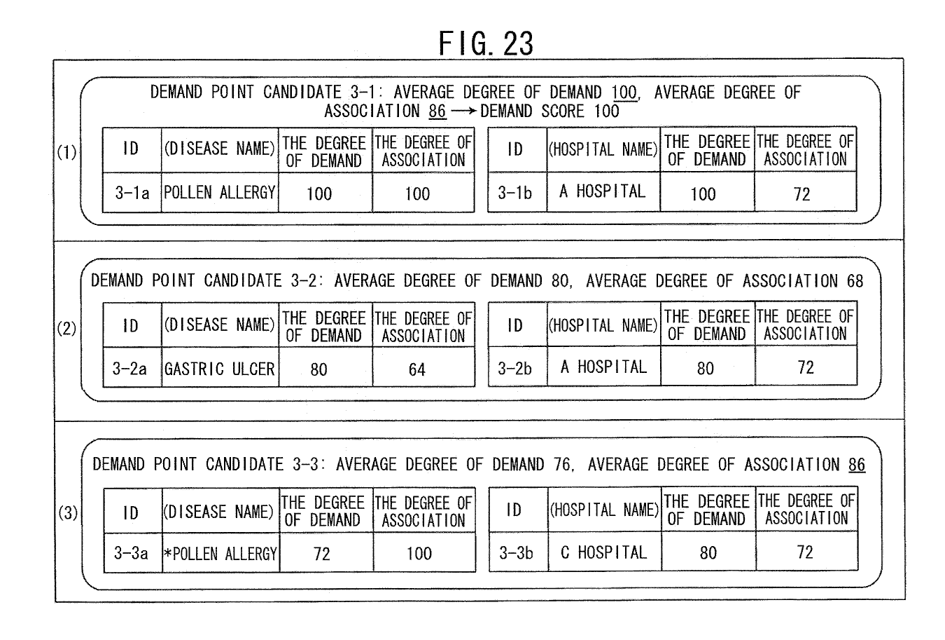

As described above, when the matching unit 35 has performed the type filling and calculation of the degree of demand/the degree of association for all the action history records, or the action history records up to a threshold value, three demand point candidates, i.e., the demand point candidates “3-1 to 3-3”, are obtained as shown in FIG. 23.

Then, the matching unit 35 calculates the degree of demand and the degree of association, which have been described above, for the obtained three demand point candidates, and narrows down the candidates to ones having the degree of association equal to or greater than a threshold value (e.g., equal to or greater than 70); as a result, the demand point candidates whose average degree of association of the keywords is “70 or more” will be the candidates “3-1” and “3-3”. Next, the matching unit 35 selects the candidate having the highest degree of demand among the narrowed down candidates. In this example, the demand point candidate “3-1” having the average degree of demand “100” is selected. Finally, since the average degree of demand of the selected candidate is determined as a demand score, the demand score in this example will be “100”.

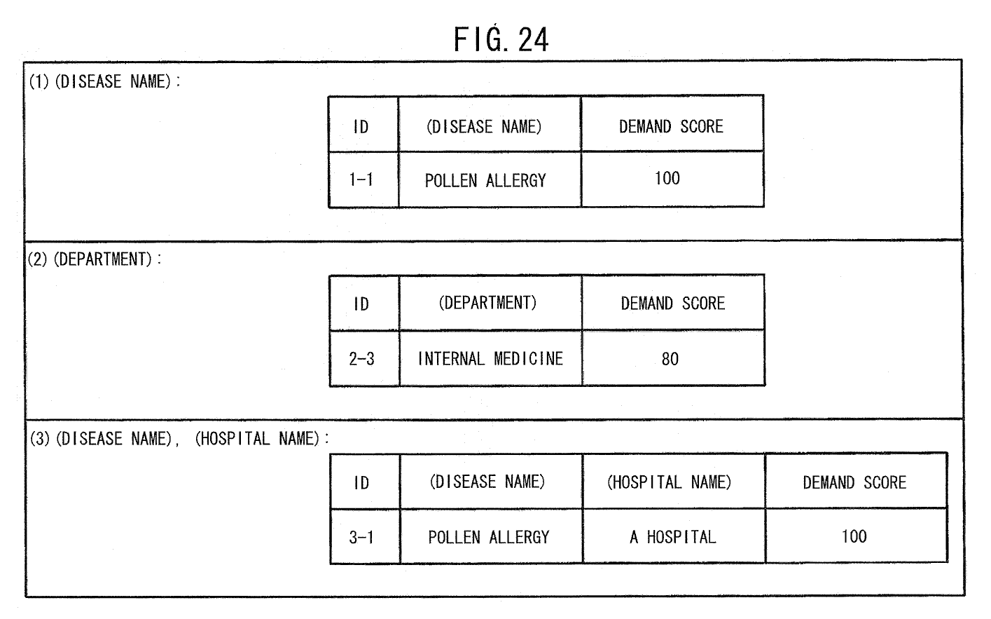

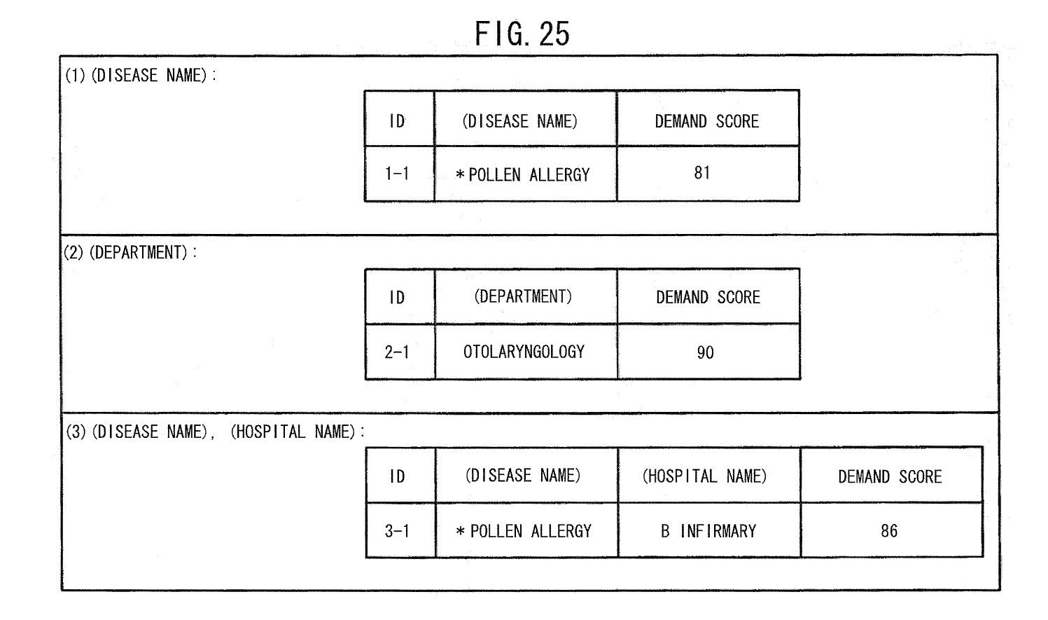

As described above, the matching unit 35 performs a series of process steps, including type filling, calculation of the degree of demand/the degree of association and demand point selection, for all the type sets selected in FIG. 19, and outputs the demand point for each obtained set. In this embodiment, the results obtained by executing the above-described process steps for the user terminals A and B are shown in FIGS. 24 and 25, respectively. FIGS. 24 and 25 show examples of demand points for the user terminals A and B, respectively, and the demand points in FIG. 24 differ from those in FIG. 25 because of different action histories.

FIG. 19 is a diagram showing sets from templates, FIG. 20 is a diagram showing an example of calculation of the degree of demand, FIG. 21 is a diagram showing an example of calculation of the degree of association, FIG. 22 is a diagram showing examples of keyword type conversion stored in the keyword conversion DB, and FIG. 23 is a diagram showing examples of selection of demand point candidates from the degree of demand and the degree of association. FIG. 24 is a diagram showing examples of results obtained by executing matching process steps for the user terminal A, and FIG. 25 is a diagram showing examples of results obtained by executing matching process steps for the user terminal B.

—Flow of Catch Phrase Generation Process Steps—

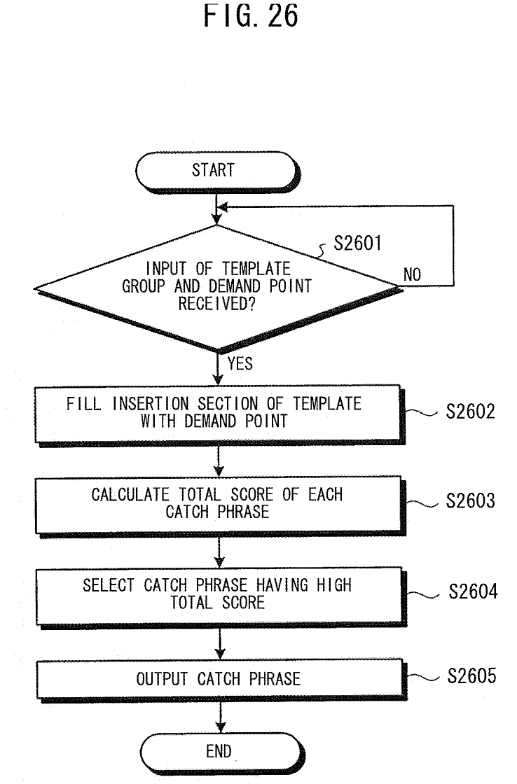

Next, referring to FIG. 26, catch phrase generation process steps performed by the catch phrase generation device will be described. FIG. 26 is a flow chart showing the flow of catch phrase generation process steps performed in the catch phrase generation device according to Embodiment 1.

As shown in FIG. 26, upon receipt of a notification that the matching process has ended and the demand points have been calculated, the catch phrase generation unit 36 of the catch phrase generation device 10 receives inputs of the template group and the demand points (i.e., when the answer is Yes in Step S2601), fills the insertion sections of the templates with the received demand points (Step S2602), calculates the total score of each catch phrase (Step S2603), selects a catch phrase having a high total score (Step S2604), and then outputs the selected catch phrase to the catch phrase output unit 37 (Step S2605).

Based on the above-described example, specific description will be given as follows. Upon input of the template “3. Why don't you introduce (hospital name) to a person having trouble with (disease name)?”, the catch phrase generation unit 36 of the catch phrase generation device 10 selects, from among the separately inputted demand point sets, the “demand point 3-1” including the type sets “disease name” and “hospital name” extracted from the template. Next, the catch phrase generation unit 36 fills the insertion sections (disease name) and (hospital name) of the template with the keywords “pollen allergy” and “A hospital” of the demand points, thereby generating a catch phrase candidate “3. Why don't you introduce A hospital to a person having trouble with pollen allergy?”. Then, the catch phrase generation unit 36 determines a total score of the catch phrase candidate from the demand score (100) of the filled demand point and the priority (1.0) of the template stored in the template DB (see FIG. 3). Since total score=demand score×priority, the total score of the catch phrase candidate will be calculated as follows: “100×1.0=100”.

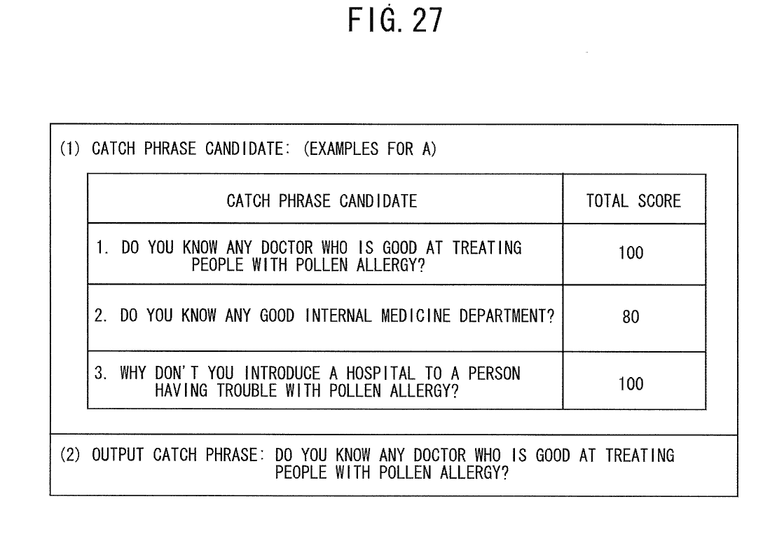

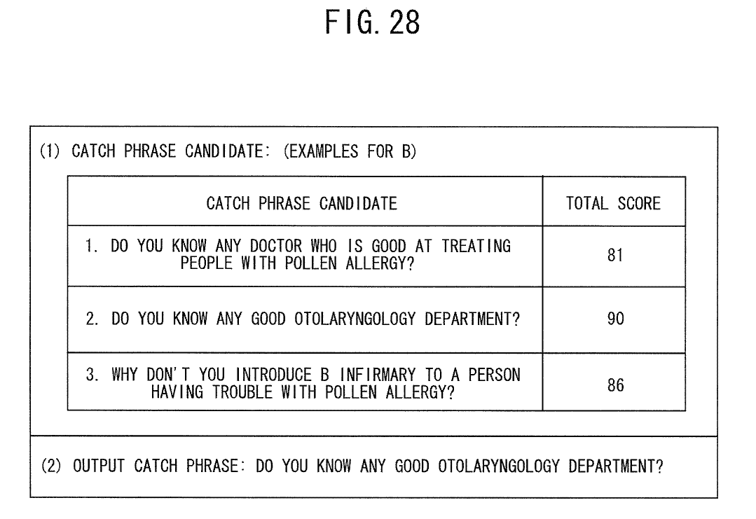

The catch phrase candidates and total scores for the user terminals A and B, which have been calculated in this manner, are shown in (1) of FIG. 27 and (1) of FIG. 28, respectively. Then, from among the created catch phrase candidates, the catch phrase generation unit 36 selects a catch phrase having a high total score, and outputs this catch phrase. In this embodiment, the catch phrase generation unit 36 outputs the catch phrase “Do you know any doctor who is good at treating people with pollen allergy?” to the user terminal A as shown in FIG. 27(2), and outputs the catch phrase “Do you know any good otolaryngology department?” to the user terminal B as shown in FIG. 28(2). The catch phrase output unit 37, which has received the catch phrases outputted in this manner, selects and outputs the catch phrase suitable for each user terminal from which access is made. It should be noted that FIG. 27 is a diagram showing an example of catch phrase selection for the user terminal A, and FIG. 28 is a diagram showing an example of catch phrase selection for the user terminal B.

### Embodiment 2

Actually, the catch phrase generation in Embodiment 1 has been described based on the example in which a bulletin board is used, but the present invention is not limited to this embodiment; alternatively, a catch phrase for selling merchandise and the like may also be generated.

Therefore, Embodiment 2 will be described based on a case where “This mask has excellent air tightness, moisture retaining property, and/or antibacterial property” is received as guidance information to generate a catch phrase suitable for a user terminal. Since a catch phrase generation device according to Embodiment 2 has a configuration similar to that of the catch phrase generation device according to Embodiment 1, the flow of overall process steps, the flow of guidance information analysis process steps, the flow of template selection process steps, the flow of action history extraction process steps, the flow of matching process steps and the flow of catch phrase generation process steps, which have been described in regard to the catch phrase generation device according to Embodiment 1, will now be described in Embodiment 2.

—Flow of Overall Process Steps—

First, the flow of overall process steps performed by the catch phrase generation device 10 according to Embodiment 2 is similar to that of overall process steps performed by the catch phrase generation device 10 according to Embodiment 1.

—Flow of Guidance Information Analysis Process Steps—

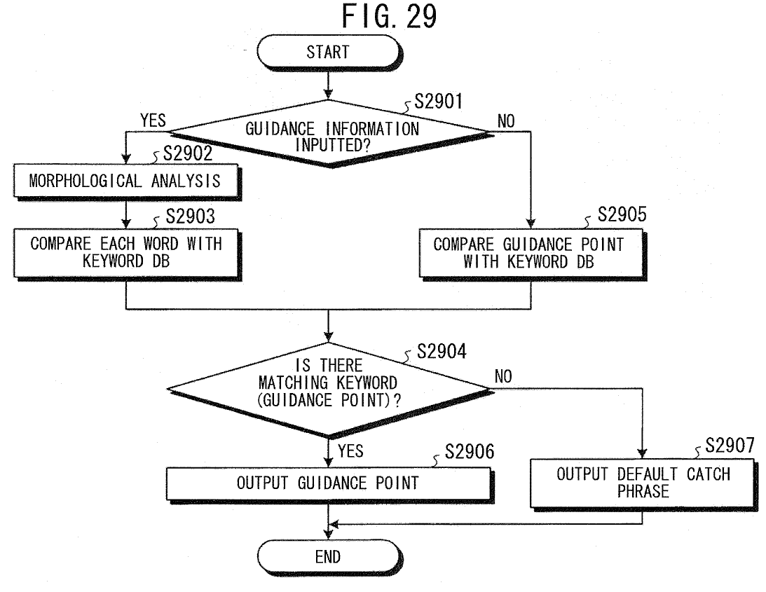

Next, referring to FIG. 29, guidance information analysis process steps performed by the catch phrase generation device will be described. FIG. 29 is a flow chart showing the flow of guidance information analysis process steps performed in the catch phrase generation device according to Embodiment 2.

As shown in FIG. 29, the guidance information analysis unit 32 of the catch phrase generation device 10 determines whether or not the inputted information is guidance information (Step S2901).

Then, when the inputted information is guidance information (i.e., when the answer is Yes in Step S2901), the guidance information analysis unit 32 performs morphological analysis and word segmentation on the inputted guidance information (Step S2902), and makes a comparison between each segmented word and the keyword DB 23 (Step S2903). When there is a matching keyword (i.e., when the answer is Yes in Step S2904), the guidance information analysis unit 32 outputs, as a guidance point, the keyword to the matching unit 35, and notifies the catch phrase output unit 37 that the process has ended (Step S2906).

On the other hand, when there is no matching keyword (i.e., when the answer is No in Step S2904), the guidance information analysis unit 32 outputs, as a default catch phrase, the inputted guidance information to the catch phrase output unit 37, and notifies the catch phrase output unit 37 that the process has ended (Step S2907).

Returning to Step S2901, when the inputted information is not guidance information, i.e., when the prespecified guidance point candidate, default catch phrase and/or application condition are/is inputted by a manager (i.e., when the answer is No in Step S2901), the guidance information analysis unit 32 makes a comparison between the inputted guidance point candidate and the keyword DB 23 (Step S2905). When there is a matching keyword (i.e., when the answer is Yes in Step S2904), the guidance information analysis unit 32 outputs, as a guidance point, the keyword to the matching unit 35 (Step S2906). When there is no matching keyword (i.e., when the answer is No in Step S2904), the guidance information analysis unit 32 outputs, as a default catch phrase, the inputted guidance information to the catch phrase output unit 37, and notifies the catch phrase output unit 37 that the process has ended (Step S2907).

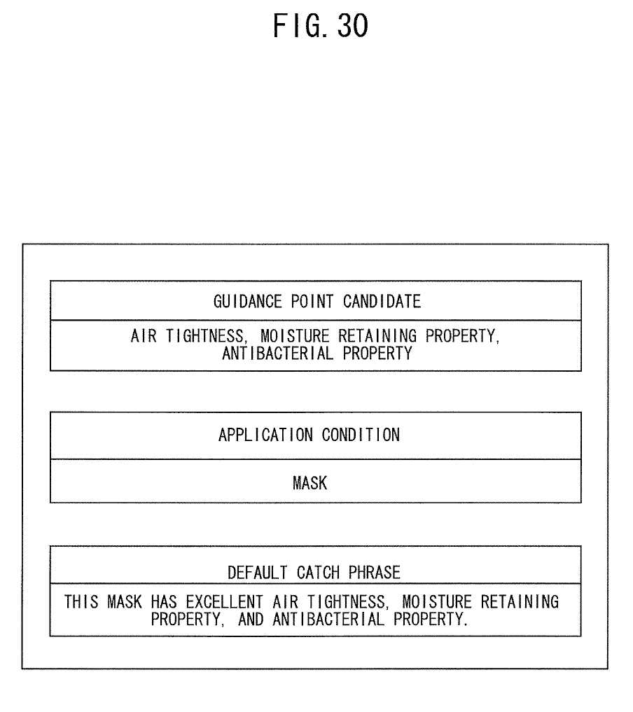

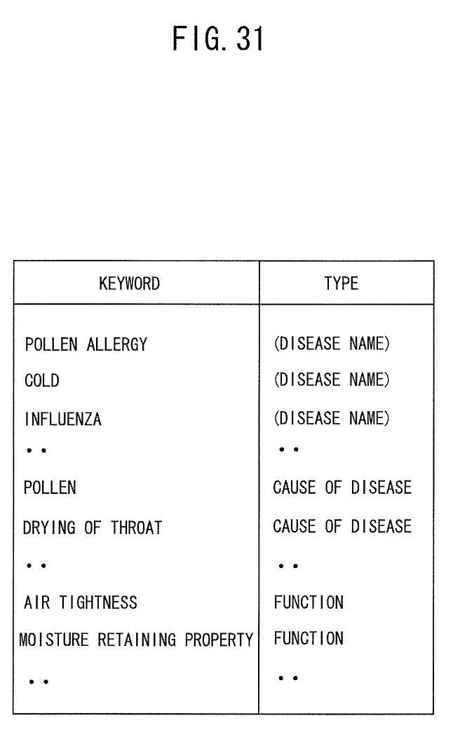

A specific example is given as follows. Upon input of guidance point candidates “air tightness”, “moisture retaining property” and “antibacterial property” shown in FIG. 30, the guidance information analysis unit 32 selects, from among respective candidates, the words “air tightness”, “moisture retaining property” and “antibacterial property” shown in FIG. 31 and stored in the keyword DB 23, and outputs, as guidance points, these words to the matching unit 35. FIG. 30 is a diagram showing guidance point candidates, default catch phrase, and application condition according to Embodiment 2, and FIG. 31 is a diagram showing exemplary information stored in the keyword DB according to Embodiment 2.

—Flow of Template Selection Process Steps—

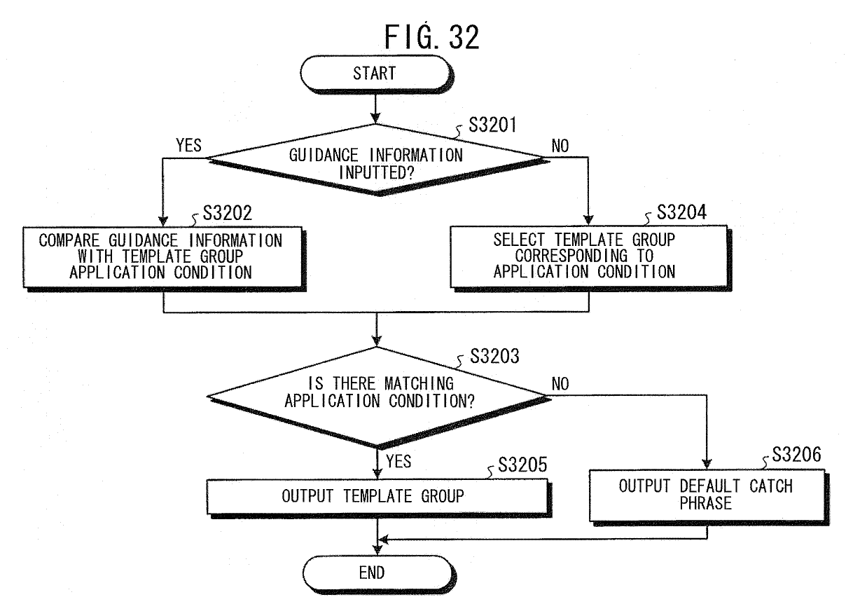

Next, referring to FIG. 32, template selection process steps performed by the catch phrase generation device will be described. FIG. 32 is a flow chart showing the flow of template selection process steps performed in the catch phrase generation device according to Embodiment 2.

As shown in FIG. 32, the template selection unit 33 of the catch phrase generation device 10, which has received a notification that the guidance information analysis process has ended, determines whether or not the inputted information is guidance information (Step S3201).

Then, when the inputted information is guidance information (i.e., when the answer is Yes in Step S3201), the template selection unit 33 makes a comparison between the inputted guidance information and application conditions of templates stored in the template DB 21 (Step S3202). When there is a matching application condition (i.e., when the answer is Yes in Step S3203), the template selection unit 33 outputs the template group corresponding to the application condition to the matching unit 35, and notifies the action history extraction unit 34 that the process has ended (Step S3205).

On the other hand, when there is no matching application condition (i.e., when the answer is No in Step S3203), the template selection unit 33 outputs, as a default catch phrase, the inputted guidance information to the catch phrase output unit 37, and notifies the action history extraction unit 34 that the process has ended (Step S3206).

Returning to Step S3201, when the inputted information is not guidance information, i.e., when the prespecified guidance point candidate, default catch phrase and/or application condition are/is inputted by a manager (i.e., when the answer is No in Step S3201), the template selection unit 33 makes a comparison between the inputted application condition and the application conditions of the templates stored in the template DB 21 (Step S3204). When there is a matching application condition (i.e., when the answer is Yes in Step S3203), the template selection unit 33 outputs the template group corresponding to the application condition to the matching unit 35 (Step S3205). When there is no matching application condition (i.e., when the answer is No in Step S3203), the template selection unit 33 outputs the default catch phrase, which has been inputted to the guidance information analysis unit 32, to the catch phrase output unit 37, and notifies the action history extraction unit 34 that the process has ended (Step S3206).

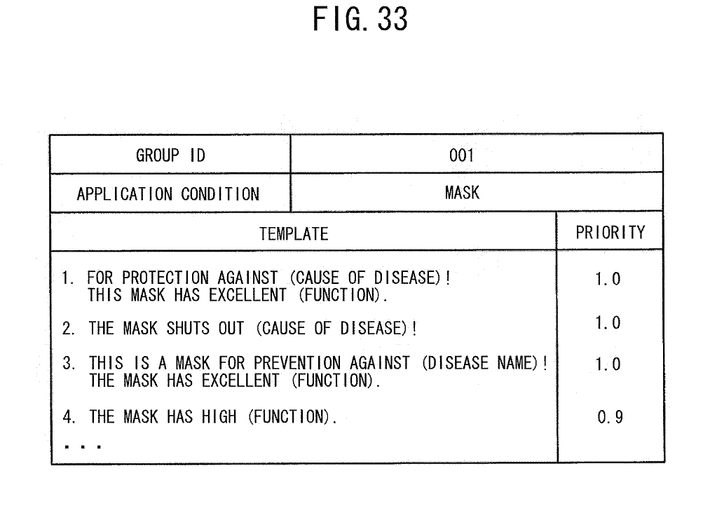

Based on the above-described example, specific description will be given as follows. Upon input of the application condition “mask” shown in FIG. 30, the template selection unit 33 selects, from the template DB 21, a template group (group ID=001) which is shown in FIG. 33, the application condition of which is identical to the inputted application condition “mask”, and outputs the selected template group (group ID=001) to the matching unit 35. It should be noted that FIG. 33 is a diagram showing an example of the template group according to Embodiment 2.

—Flow of Action History Extraction Process Steps—

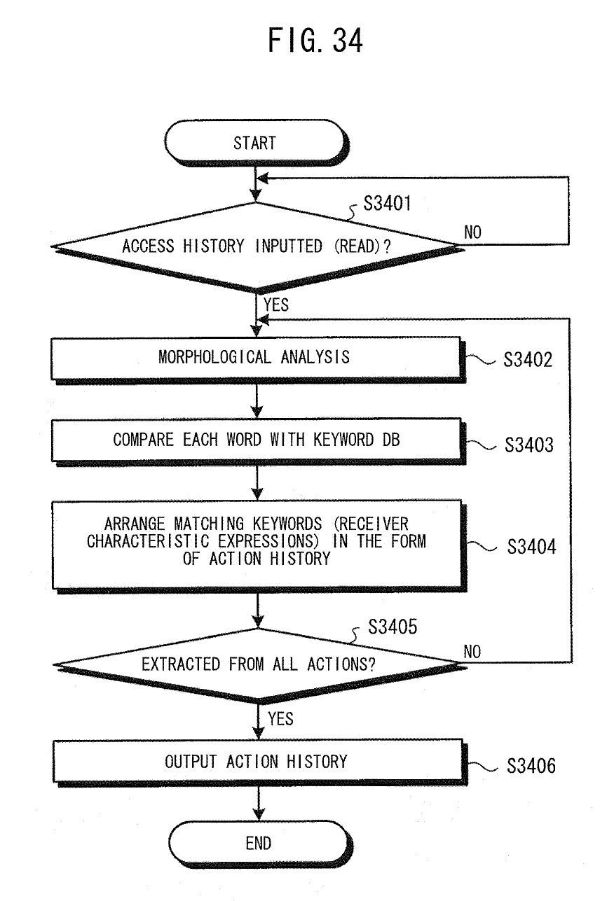

Next, referring to FIG. 34, action history extraction process steps performed by the catch phrase generation device will be described. FIG. 34 is a flow chart showing the flow of action history extraction process steps performed in the catch phrase generation device according to Embodiment 2.

As shown in FIG. 34, the action history extraction unit 34 of the catch phrase generation device 10, which has received a notification that the template selection process has ended, reads an access history (Step S3401), performs morphological analysis and word segmentation on the read access history to determine parts of speech (Step S3402), makes a comparison between each segmented word and each keyword stored in the keyword DB 23 (Step S3403), and arranges matching keywords in the form of an action history (Step S3404).

Then, when the foregoing process steps of Step S3402 to Step S3404 have been executed on all the access histories (i.e., when the answer is Yes in Step S3405), the action history extraction unit 34 outputs the action history, which has been created at Step S3404, to the action history DB 22, and notifies the matching unit 35 that the process has ended (Step S3406). When the foregoing process steps of Step S3402 to Step S3404 have not been executed on all the access histories (i.e., when the answer is No in Step S3405), the process is returned to Step S3402, and the process steps of Step S3402 to Step S3405 are executed.

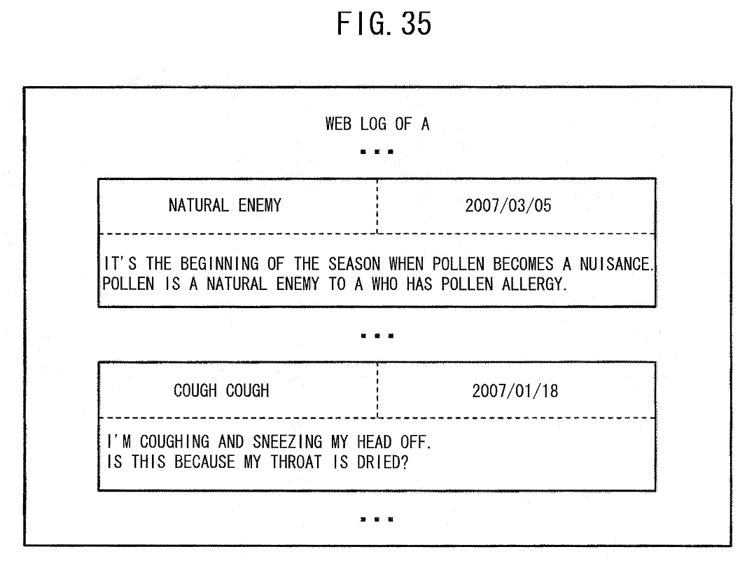

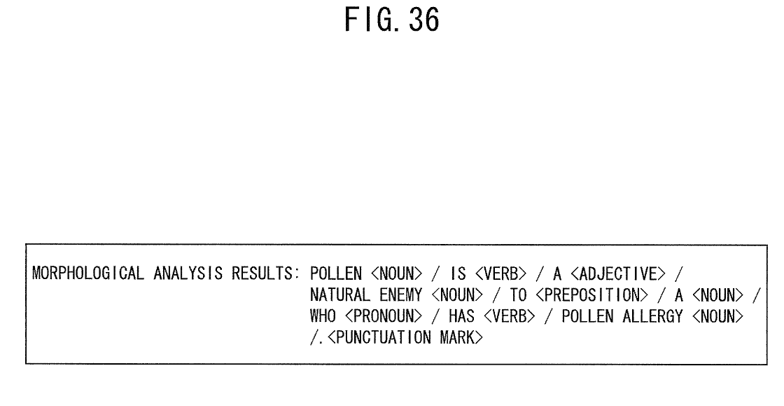

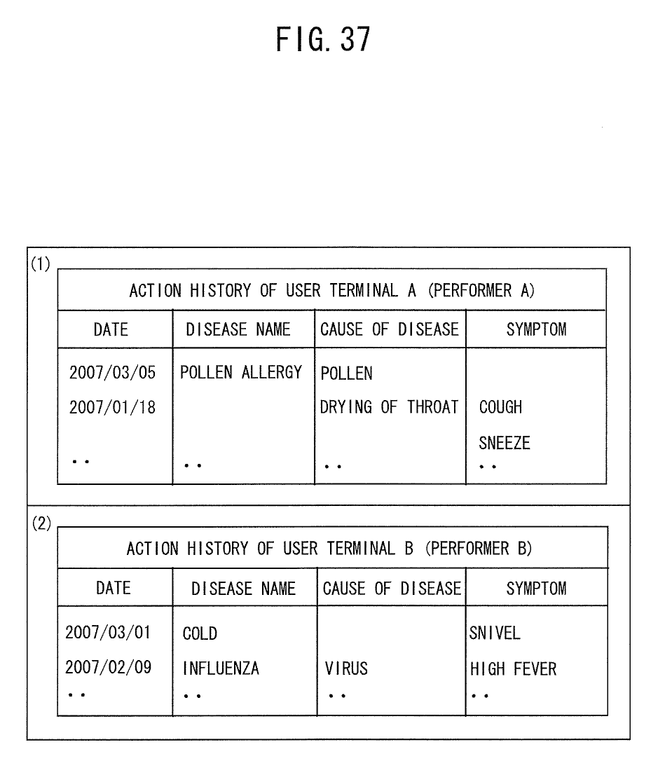

More specifically, the action history extraction unit 34 of the catch phrase generation device 10, which has received a notification that the template selection process has ended, reads an access history of web log posting shown in FIG. 35, performs morphological analysis and word segmentation on the read access history to determine parts of speech as shown in FIG. 36, makes a comparison between each segmented word and each keyword stored in the keyword DB 23, arranges matching keywords in the form of an action history for each user terminal (performer) as shown in FIG. 37, and then outputs the action history to the action history DB 22. It should be noted that FIG. 35 is a diagram showing an example of the access history (web log posting) according to Embodiment 2, FIG. 36 is a diagram showing an example of the morphological analysis according to Embodiment 2, and FIG. 37 is a diagram showing examples of action history extraction results according to Embodiment 2.

—Flow of Matching Process Steps—

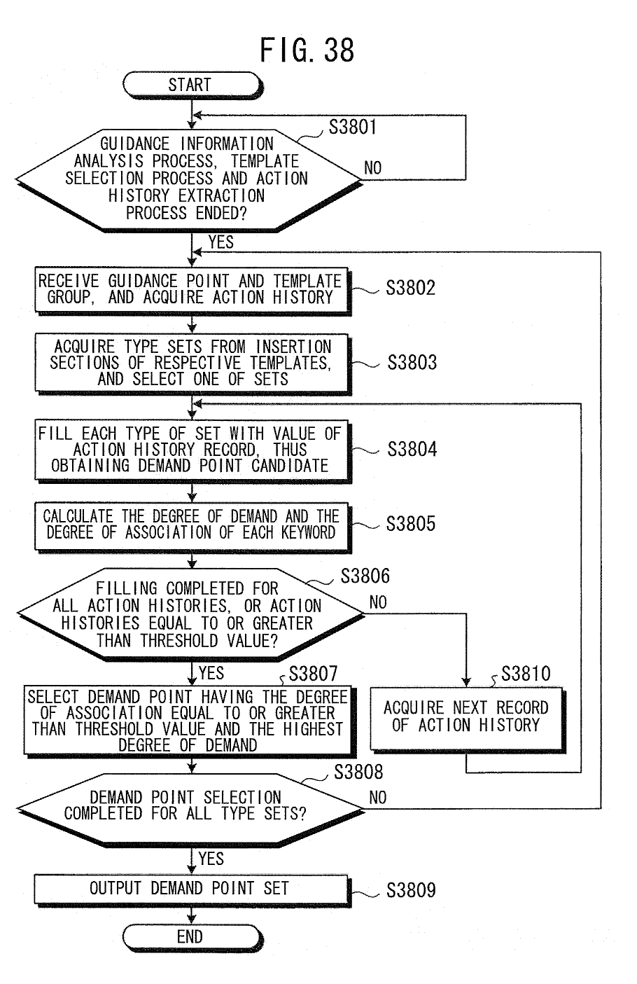

Next, referring to FIG. 38, matching process steps performed by the catch phrase generation device will be described. FIG. 38 is a flow chart showing the flow of matching process steps performed in the catch phrase generation device according to Embodiment 2.

As shown in FIG. 38, upon receipt of a notification that the guidance information analysis process, the template selection process and the action history extraction process have ended (i.e., when the answer is Yes in Step S3801), the matching unit 35 of the catch phrase generation device 10 receives the “guidance point” outputted from the guidance information analysis unit 32 and the “template group” outputted from the template selection unit 33, and acquires the “action history” stored in the action history DB 22 (Step S3802).

Then, the matching unit 35 acquires, as sets, the insertion sections of respective templates of the received template group, selects one of the sets (Step S3803), and inserts values (keywords) of the action history record stored in the action history DB 22 into the selected set, thus obtaining a demand point candidate (Step S3804).

Subsequently, the matching unit 35 calculates the degree of demand and the degree of association of each keyword inserted into the set (Step S3805), and determines whether or not the insertion has been completed for all the action histories, or the action histories equal to or greater than a threshold value (Step S3806). Subsequent to this, when the insertion has been completed (i.e., when the answer is Yes in Step S3806), the matching unit 35 selects a demand point having the degree of association equal to or greater than a threshold value and the highest degree of demand (Step S3807), and determines whether or not the selection of the demand point has been completed for all the sets (Step S3808). Then, when the selection of the demand point has been completed for all the sets (i.e., when the answer is Yes in Step S3808), the matching unit 35 outputs the set, into which the demand point has been inserted, to the catch phrase generation unit 36 (Step S3809).

On the other hand, when the insertion has not been completed for all the action histories, or the action histories equal to or greater than the threshold value (i.e., when the answer is No in Step S3806), the matching unit 35 acquires the next action history record stored in the action history DB 22 (Step S3810), returns the process to Step S3804, and executes the process steps of Step S3804 to Step S3806. When the selection of the demand point has not been completed for all the sets (i.e., when the answer is No in Step S3808), the matching unit 35 returns the process to Step S3802, and executes the process steps of Step S3802 to Step S3808.

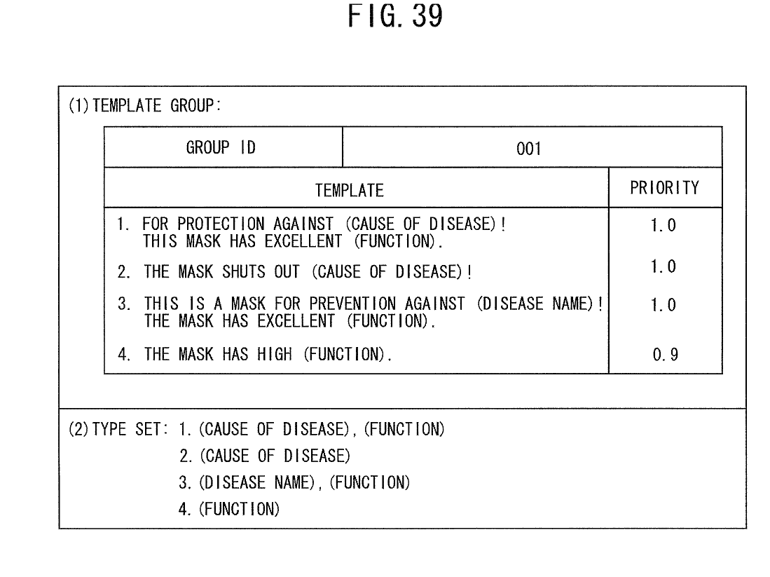

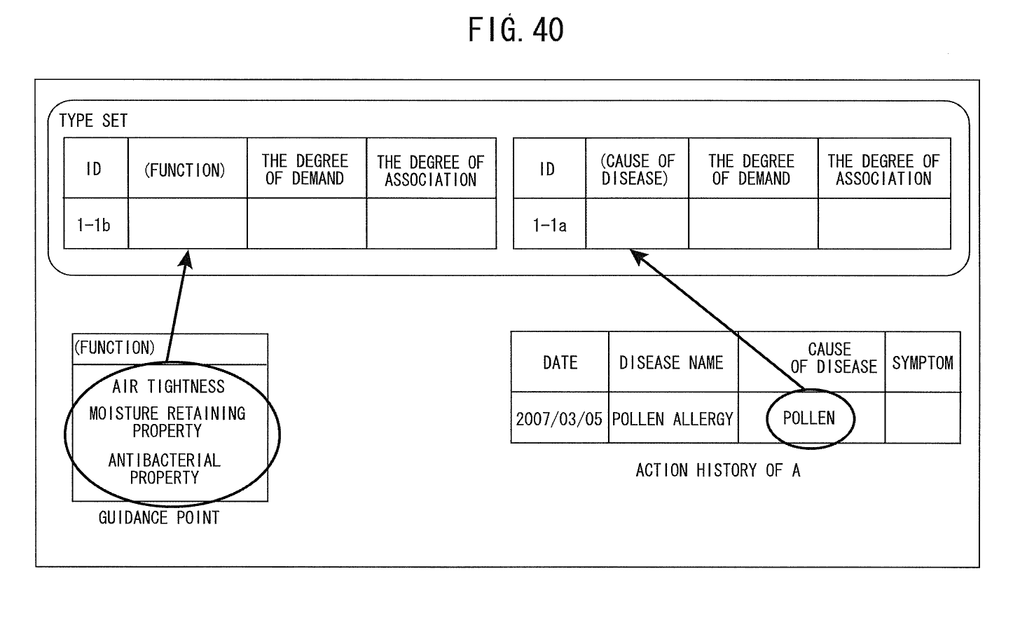

Now, the foregoing example will be more specifically described for the user terminal A with regard to Step S3801 to Step S3810. As shown in FIG. 39, the matching section 35, which has acquired the “guidance point”, the “template group” and the “action history”, acquires, as sets, “1. cause of disease, function”, “2. cause of disease”, “3. disease name, function” and “4. function” which are insertion sections of respective templates of the received template group. Then, the matching unit 35 selects one of the sets (for example, “1. cause of disease, function”), and as shown in FIG. 40, the matching unit 35 fills the set with the guidance points “air tightness, moisture retaining property, and antibacterial property” and the action history record “pollen allergy” stored in the action history DB 22, thus determining this set as a demand point candidate.

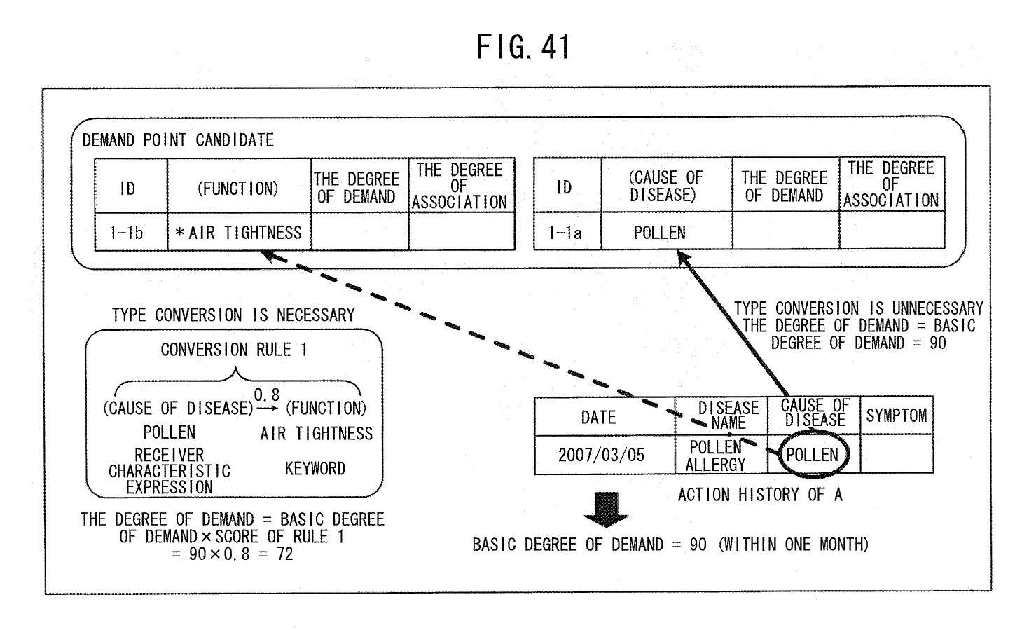

Subsequently, as shown in FIG. 41, the matching section 35 calculates the “degree of demand” of the selected keywords “2007/03/05, pollen allergy, pollen, −” as: “basic degree of demand=100” when the date of the selected keywords stored in the action history DB 22 is within a week of the date at which the guidance information was inputted; “basic degree of demand=90” when the date of the selected keywords stored in the action history DB 22 is within a month of the date at which the guidance information was inputted; and “basic degree of demand=80” when the date of the selected keywords stored in the action history DB 22 is within three months of the date at which the guidance information was inputted. In this case, if the date at which the guidance information was inputted is “2007/04/01”, since the action was performed on “2007/03/05” and the date of which is within a month of the date at which the guidance information was inputted, the basic degree of demand will be “90”.

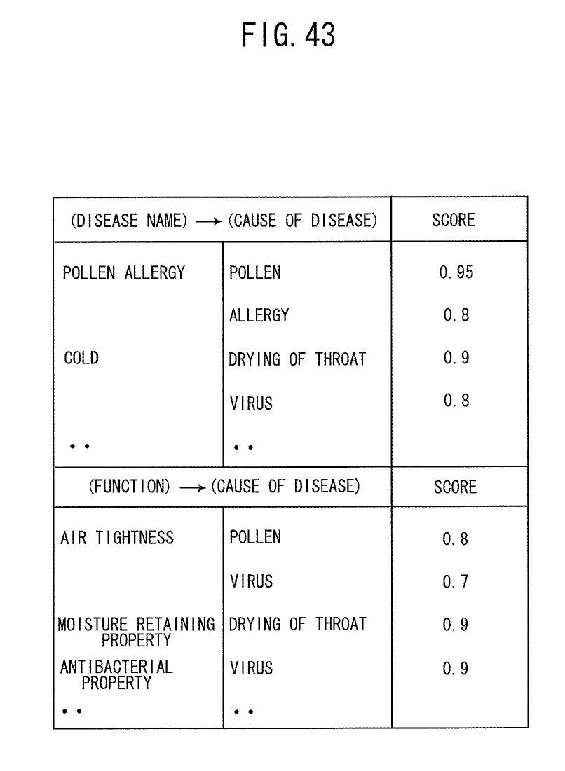

Then, the keyword “pollen (cause of disease)” is a keyword filled from the action history record, and therefore, the degree of demand of this keyword will be “90” which is the same as the basic degree of demand. On the other hand, since the keywords “air tightness, moisture retaining property, and antibacterial property (function)” are keywords of the type which does not exist in the action history record, type conversion is necessary. In this example, the matching unit 35 uses a keyword conversion rule as shown in FIG. 43 to perform type conversion from “pollen (cause of disease)” and/or “pollen allergy (disease name)” of the action history to “air tightness (function)”, “moisture retaining property (function)” and/or “antibacterial property (function)”. When there are several type conversion candidates, the matching unit 35 selects one having the smallest number of conversions. If the rule with the smallest number of conversions is searched for, it can be seen that, as shown in FIG. 41, there is (Rule 1) for “pollen→air tightness” as a conversion rule for “(cause of disease)→(function)”, and therefore, the matching unit 35 selects “air tightness” as (function) for the demand point candidate in this case. Then, since the degree of demand of the keyword “air tightness (function)” is determined by “basic degree of demand×score of Rule 1”, the matching unit 35 calculates the degree of demand of the keyword “air tightness (function)” as “90×0.8=72”.

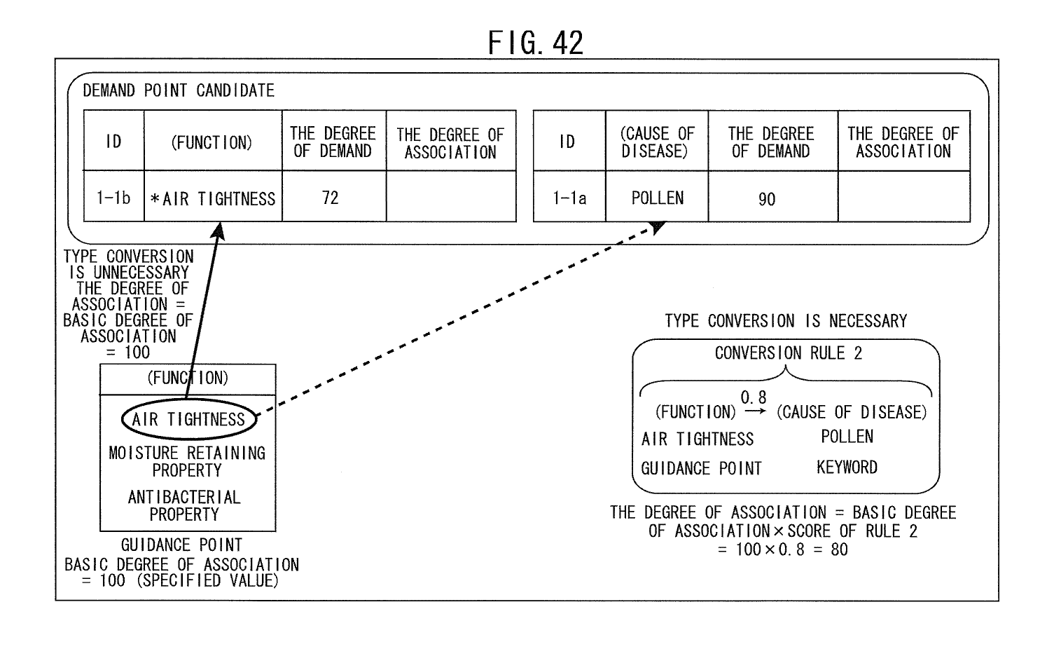

Subsequently, as shown in FIG. 42, the matching unit 35 calculates the degree of association of each selected “keyword”. When “guidance point=air tightness, moisture retaining property or antibacterial property”, acquired by the guidance information analysis process (FIGS. 8 to 11) performed by the guidance information analysis section 32, is identical to the selected “keyword”, the matching unit 35 determines the “degree of association” as “100 (basic degree of association)”. Accordingly, since the keyword “air tightness” is identical to the guidance point, the matching unit 35 calculates the degree of association thereof as “100” which is the same as the basic degree of association.

On the other hand, since “pollen (cause of disease)” is different in type from the guidance point, type conversion is necessary. To this end, the matching unit 35 uses a keyword type conversion rule as shown in FIG. 43 to perform type conversion from the guidance point “air tightness (function)” to “pollen (cause of disease)”. If the rule is searched for, it can be seen that, as shown in FIG. 42, there is (Rule 2) for “air tightness→pollen” as a conversion rule for “(function)→(cause of disease)”. Hence, since the degree of association of the keyword “pollen (cause of disease)” is determined by “basic degree of association×score of Rule 2”, the matching unit 35 calculates the degree of association of the keyword “pollen (cause of disease)” as “100×0.8=80”.

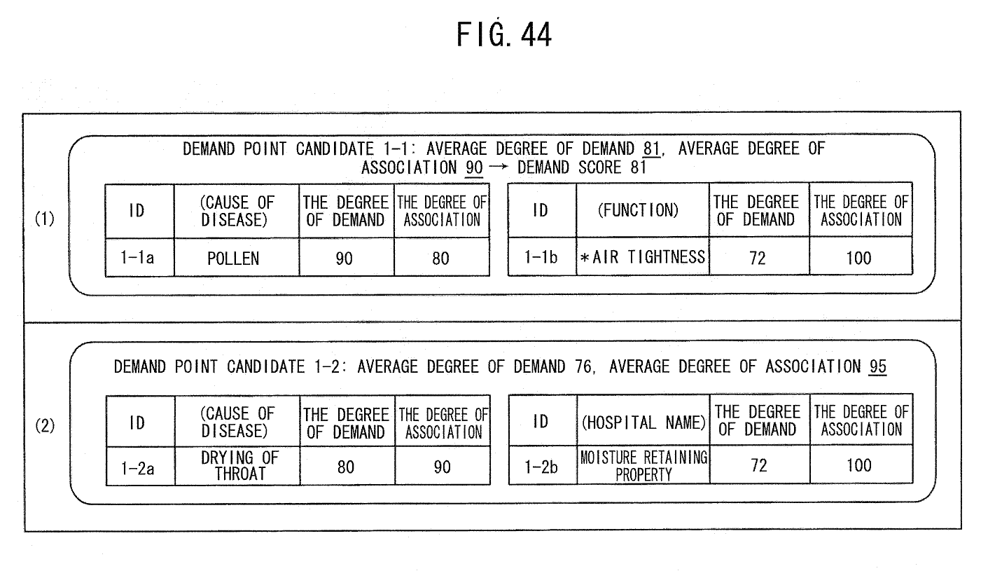

As described above, when the matching unit 35 has performed type filling and calculation of the degree of demand/the degree of association for all the action history records, or the action history records up to a threshold value, two demand point candidates, i.e., the demand point candidates “1-1 and 1-2”, are obtained as shown in FIG. 44.

Then, the matching unit 35 calculates the degree of demand and the degree of association, which have been described above, for the obtained two demand point candidates, and narrows down the candidates to ones having the degree of association equal to or greater than a threshold value (e.g., equal to or greater than 70); as a result, the demand point candidates whose average degree of association of the keywords is “70 or more” will be the candidates “1-1” and “1-2”. Next, the matching unit 35 selects the candidate having the highest degree of demand among the narrowed down candidates. In this example, the demand point candidate “1-1” having the average degree of demand “81” is selected. Finally, since the average degree of demand of the selected candidate is determined as a demand score, the demand score in this example will be “81”.

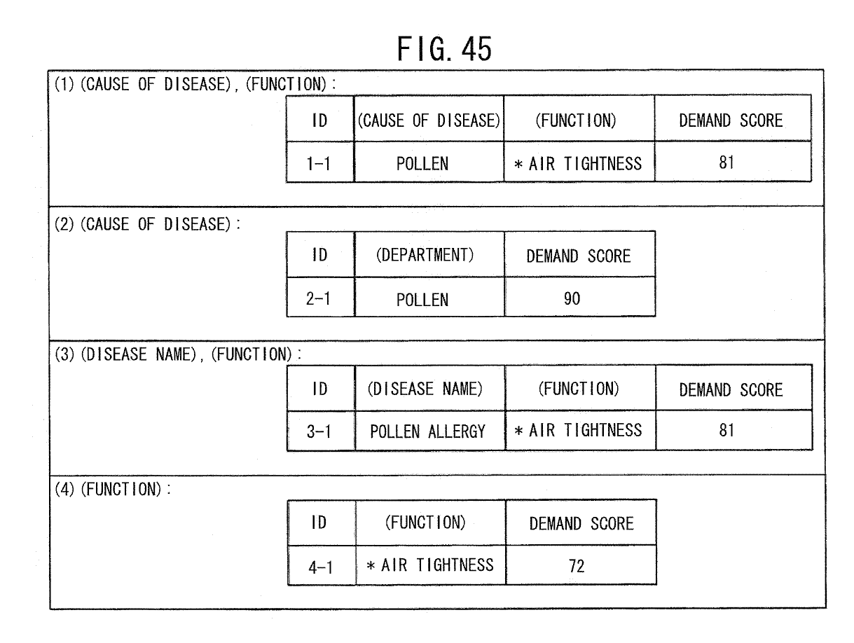

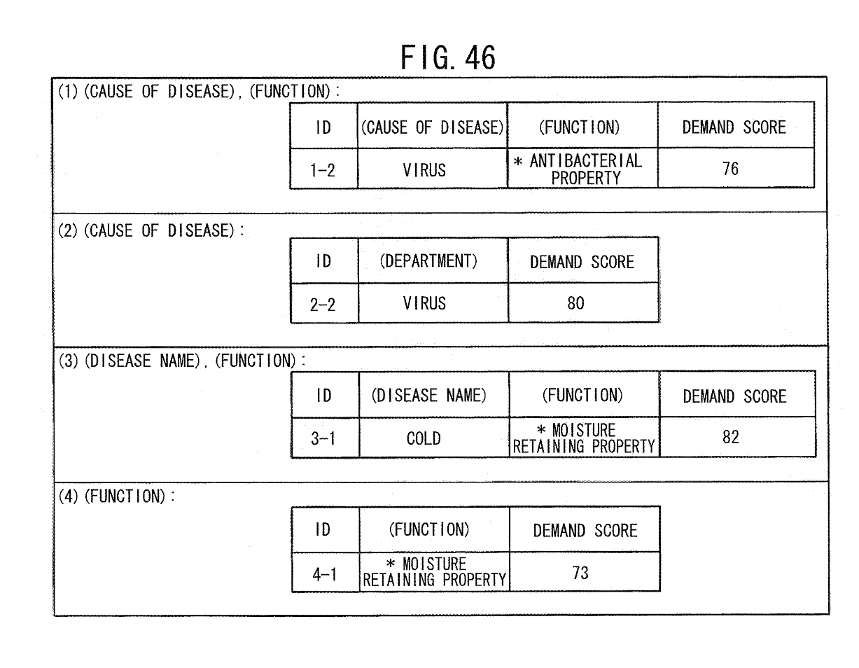

As described above, the matching unit 35 performs a series of process steps, including type filling, calculation of the degree of demand/the degree of association and demand point selection, for all the type sets selected in FIG. 39, and outputs the demand point for each obtained set. In this embodiment, the results obtained by executing the above-described process steps for the user terminals A and B are shown in FIGS. 45 and 46, respectively. FIGS. 45 and 46 show examples of demand points for the user terminals A and B according to Embodiment 2, respectively, and the demand points in FIG. 45 differ from those in FIG. 46 because of different action histories.

It should be noted that FIG. 39 is a diagram showing sets from templates in Embodiment 2, FIG. 40 is a diagram showing an example of demand point extraction in Embodiment 2, FIG. 41 is a diagram showing an example of calculation of the degree of demand in Embodiment 2, and FIG. 42 is a diagram showing an example of calculation of the degree of association in Embodiment 2. FIG. 43 is a diagram showing examples of keyword type conversion stored in the keyword conversion DB in Embodiment 2. FIG. 44 is a diagram showing examples of selection of demand point candidates from the degree of demand and the degree of association in Embodiment 2, and FIG. 45 is a diagram showing examples of results obtained by executing matching process steps for the user terminal A in Embodiment 2. FIG. 46 is a diagram showing examples of results obtained by executing matching process steps for the user terminal B in Embodiment 2.

—Flow of Catch Phrase Generation Process Steps—

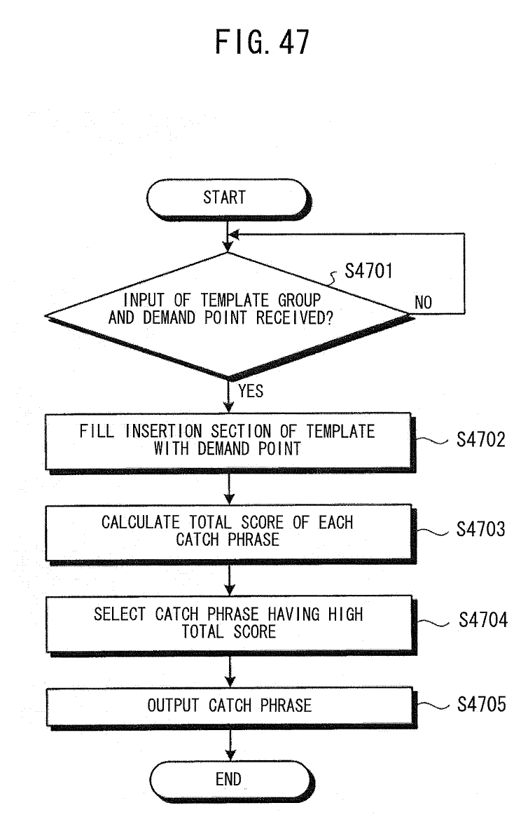

Next, referring to FIG. 47, catch phrase generation process steps performed by the catch phrase generation device will be described. FIG. 47 is a flow chart showing the flow of catch phrase generation process steps performed in the catch phrase generation device according to Embodiment 2.

As shown in FIG. 47, upon receipt of a notification that the matching process has ended and the demand points have been calculated, the catch phrase generation unit 36 of the catch phrase generation device 10 receives inputs of the template group and the demand points (i.e., when the answer is Yes in Step S4701), fills the insertion sections of the templates with the received demand points (Step S4702), calculates the total score of each catch phrase (Step S4703), selects a catch phrase having a high total score (Step S4704), and then outputs the selected catch phrase to the catch phrase output unit 37 (Step S4705).

Based on the above-described example, specific description will be given as follows. Upon input of the template “1. For protection against (cause of disease)! This mask has excellent (function).”, the catch phrase generation unit 36 of the catch phrase generation device 10 selects, from among the separately inputted demand point sets, the demand point “1-1” including the type sets “(cause of disease) and (function)” extracted from the template. Next, the catch phrase generation unit 36 fills the insertion sections “(cause of disease), and (function)” of the template with the keywords “pollen” and “air tightness” of the demand point, thereby generating a catch phrase candidate “1. For protection against pollen! This mask has excellent air tightness.”. Then, the catch phrase generation unit 36 determines a total score of the catch phrase candidate from the demand score (81) of the filled demand point and the priority (1.0) of the template. Since “total score=demand score×priority”, the total score of the catch phrase candidate will be calculated as follows: “81×1.0=81”.

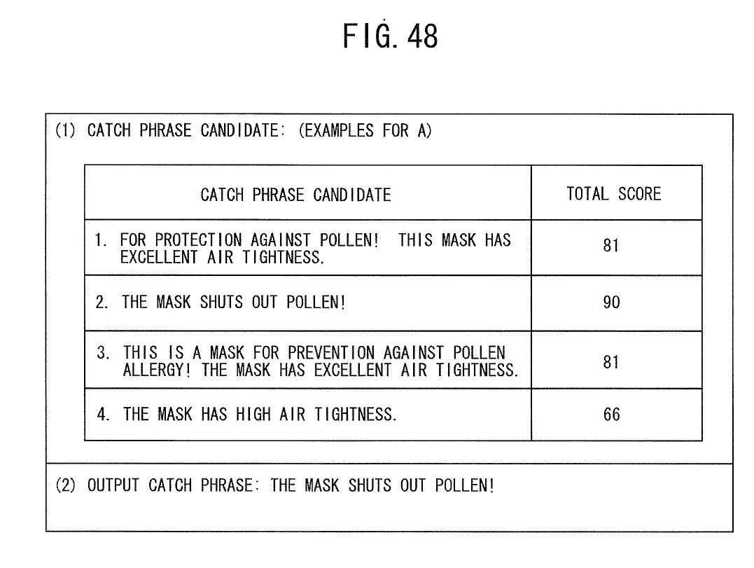

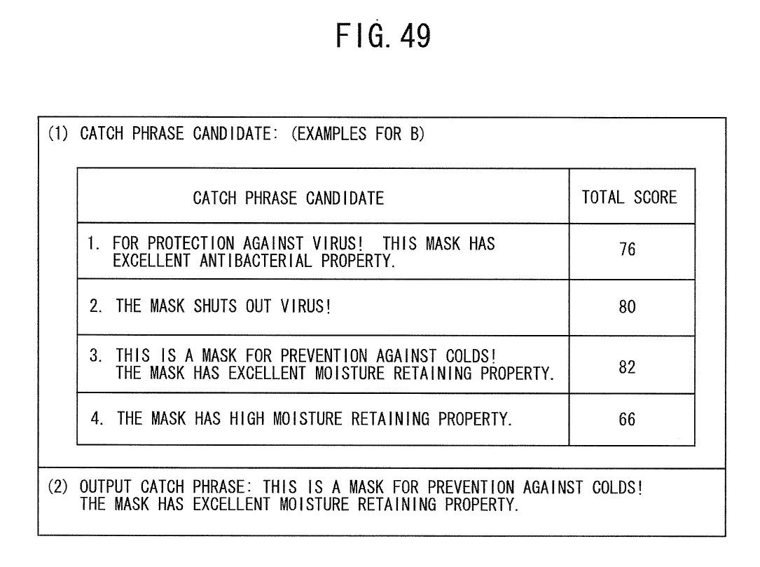

The catch phrase candidates and total scores for the user terminals A and B, which have been calculated in this manner, are shown in (1) of FIG. 48 and (1) of FIG. 49, respectively. Then, from among the created catch phrase candidates, the catch phrase generation unit 36 selects a catch phrase having a high total score, and outputs this catch phrase. In this embodiment, the catch phrase generation unit 36 outputs the catch phrase “The mask shuts out pollen!” to the user terminal A as shown in FIG. 48(2), and outputs the catch phrase “This is a mask for prevention against colds! The mask has excellent moisture retaining property.” to the user terminal B as shown in FIG. 49(2). The catch phrase output unit 37, which has received the catch phrases outputted in this manner, selects and outputs the catch phrase suitable for each user terminal from which access is made. FIG. 48 is a diagram showing an example of catch phrase selection for the user terminal A in Embodiment 2, and FIG. 49 is a diagram showing an example of catch phrase selection for the user terminal B in Embodiment 2.

### Embodiment 3

Although the embodiments of the present invention have been described thus far, the present invention may be implemented in various forms other than the foregoing embodiments. Therefore, as shown below, other embodiments will be described in regard to (1) catch phrase generation object, (2) system configuration, etc. and (3) program.

(1) Catch Phrase Generation Object

For example, in Embodiment 1, the catch phrase generation has been described based on the example in which a bulletin board is used, and in Embodiment 2, the catch phrase generation has been described based on the example in which a mask is used, but the present invention is not limited to these embodiments. For example, various catch phrases, such as catch phrases for homepages and catch phrases for books and/or companies, may be generated.

(2) System Configuration, Etc.

Further, respective constituting elements of each device shown in the drawings are provided based on functional concepts, and they do not necessarily have to be physically configured as shown in the drawings. In other words, a specific form of distribution/integration of each device is not limited to one shown in the drawings, and the entire system thereof or a part of the system thereof may be configured by functional or physical distribution/integration in any unit (e.g., by integrating the catch phrase generation section with the catch phrase output section) in accordance with various loads, use situation and the like. Moreover, the entire or any part of each process function, performed in each device, may be implemented by a CPU and a program analyzed and executed by the CPU, or may be implemented as hardware using wired logic.

(3) Program

Actually, the various processes described in the foregoing embodiments can be implemented by executing programs, which have been prepared in advance, by a computer system such as a personal computer or a work station. Therefore, a computer system for executing programs having functions similar to those of the foregoing embodiments will be described below as another embodiment.

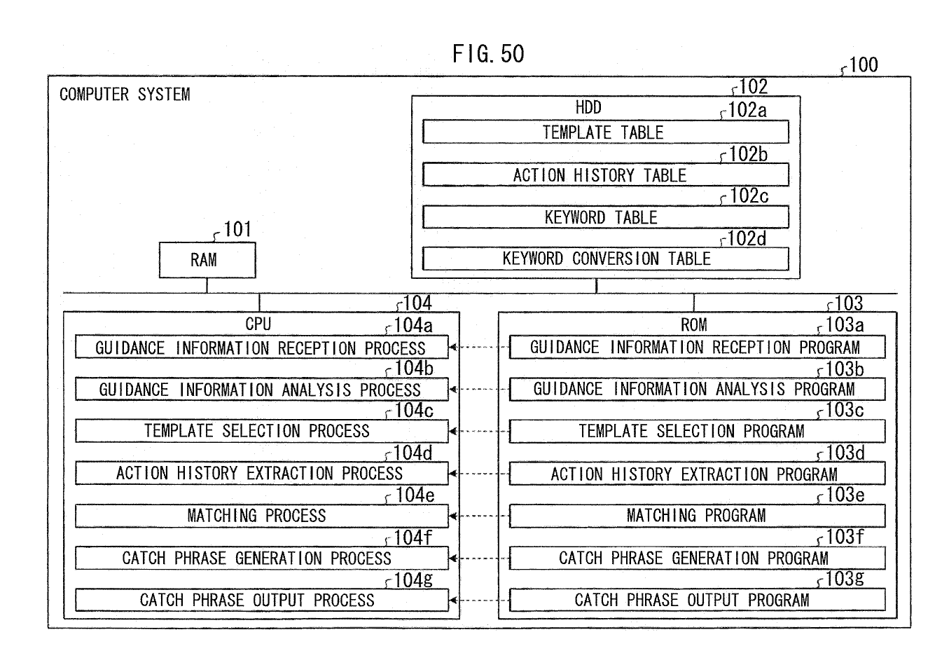

FIG. 50 is a diagram showing an example of a computer system for executing a catch phrase generation program. As shown in FIG. 50, a computer system 100 includes a RAM 101, an HDD 102, a ROM 103 and a CPU 104. In this system, the ROM 103 stores, in advance, programs for performing functions similar to those of the foregoing embodiments, i.e., a guidance information reception program 103a, a guidance information analysis program 103b, a template selection program 103c, an action history extraction program 103d, a matching program 103e, a catch phrase generation program 103f, and a catch phrase output program 103g as shown in FIG. 50.

Furthermore, the CPU 104 reads and executes these programs 103a to 103g, thus performing a guidance information reception process 104a, a guidance information analysis process 104b, a template selection process 104c, an action history extraction process 104d, a matching process 104e, a catch phrase generation process 104f, and a catch phrase output process 104g as shown in FIG. 50. The guidance information reception process 104a is associated with the guidance information reception section 31 shown in FIG. 2. Similarly, the guidance information analysis process 104b is associated with the guidance information analysis unit 32, the template selection process 104c is associated with the template selection unit 33, and the action history extraction process 104d is associated with the action history extraction unit 34. The matching process 104e is associated with the matching unit 35, the catch phrase generation process 104f is associated with the catch phrase generation unit 36, and the catch phrase output process 104g is associated with the catch phrase output unit 37.

Moreover, the HDD 102 is provided with: a template table 102a for storing, in a grouped manner, a plurality of templates each having an insertion section for which a keyword property that should be inserted is determined in advance; an action history table 102b for storing, for each distribution destination device, a keyword extracted from the past access history of the distribution destination device; a keyword table 102c for storing, in association with each other, a plurality of keywords each indicating a characteristic of a user, and a property to which each of the plurality of keywords belongs; and a keyword conversion table 102d for storing, in association with a keyword, a conversion keyword belonging to a property having a meaning associated with the keyword and different from the property of the keyword, and the degree of association between the keyword and the conversion keyword. The template table 102a corresponds to the template DB 21 shown in FIG. 2, and the action history table 102b corresponds to the action history DB 22. The keyword table 102c corresponds to the keyword DB 23, and the keyword conversion table 102d corresponds to the keyword conversion DB 24.

Actually, the programs 103a to 103g described above do not necessarily have to be stored in the ROM 103. For example, other than a “portable physical medium” such as a flexible disk (FD), a CD-ROM, a DVD (Digital Versatile Disk), a magneto-optical (MO) disk or an IC card which is insertable into the computer system 100, the programs 103a to 103g may be stored in a “fixed physical medium” such as a hard disk drive (HDD) which is provided inside/outside the computer system 100. The programs 103a to 103g may further be stored in “another computer system” connected via a public line, the Internet, a LAN and/or a WAN to the computer system 100. And the computer system 100 may read the programs from these media to execute the programs.

What is claimed is:

1. A catch phrase generation device for generating a catch phrase from guidance information desired to be provided to a user, and outputting the generated catch phrase to the user, said catch phrase generation device comprising:
keyword storage unit that stores, in association with each other, a plurality of keywords each indicating a characteristic of the user, and a property to which each of the plurality of keywords belongs;
template storage unit that stores a plurality of templates each having an insertion section for which a keyword property that should be inserted is determined in advance;
template selection unit that selects, from the template storage unit, a template corresponding to the guidance information based on a predetermined condition;
keyword acquisition unit that analyses an access history, which has been created by the user or to which the user has made reference, and acquires, based on an analyzed result, a keyword stored in the keyword storage unit; and
catch phrase generation unit that selects, from among the keywords acquired by the keyword acquisition unit, a keyword belonging to a property identical to the property determined for the insertion section of the template selected from the template storage unit by the template selection unit, and inserting the selected keyword into the insertion section of the template, thereby generating a catch phrase.

2. The catch phrase generation device according to claim 1,
wherein the catch phrase generation device further comprises conversion keyword storage unit that stores, in association with the keyword, a conversion keyword belonging to a property having a meaning associated with the keyword and different from the property of the keyword, and
wherein when the property of the keyword acquired by the keyword acquisition unit is not identical to the property determined for the insertion section of the template selected from the template storage unit, the catch phrase generation unit makes reference to the conversion keyword storage unit, converts the keyword, acquired by the keyword acquisition unit, into a conversion keyword the property of which is identical to the property of the insertion section, and inserts the converted keyword into the insertion section of the template, thereby generating a catch phrase.

3. The catch phrase generation device according to claim 2,
wherein the template storage unit stores, in a grouped manner, a plurality of templates,
wherein the conversion keyword storage unit further stores the degree of association between the keyword and the conversion keyword,
wherein the template selection unit selects, from the template storage unit, a group of templates corresponding to the guidance information based on a predetermined condition, and
wherein the catch phrase generation unit inserts a keyword acquired by the keyword acquisition unit or a conversion keyword into an insertion section of each template included in the template group selected by the template selection unit, calculates a first association value based on the degree of association of the inserted keyword or conversion keyword stored in the conversion keyword storage unit, and on the timing of an access history analyzed by the keyword acquisition unit, and determines, as a catch phrase, a template having the highest calculated first association value.

4. The catch phrase generation device according to claim 3,
wherein the catch phrase generation device further comprises guidance point acquisition unit for segmenting the guidance information into words, and acquiring, when the segmented words are stored in the keyword storage unit, the words and properties as guidance points, and
wherein the catch phrase generation unit calculates a second association value based on the degree of association of the inserted keyword or conversion keyword, and on the guidance points acquired by the guidance point acquisition unit, and further uses the first association value and the calculated second association value to select a catch phrase from the plurality of templates.

5. A computer-readable recording medium that records a catch phrase generation program for allowing a computer to generate a catch phrase from guidance information desired to be provided to a user, and to output the generated catch phrase to the user,
wherein the catch phrase generation program allows the computer to function as:
keyword storage unit that stores, in association with each other, a plurality of keywords each indicating a characteristic of the user, and a property to which each of the plurality of keywords belongs;
template storage unit that stores a plurality of templates each having an insertion section for which a keyword property that should be inserted is determined in advance;
template selection unit that selects, from the template storage unit, a template corresponding to the guidance information based on a predetermined condition;
keyword acquisition unit that analyzes an access history, which has been created by the user or to which the user has made reference, and acquiring, based on an analyzed result, a keyword stored in the keyword storage unit; and
catch phrase generation unit that selects, from among the keywords acquired by the keyword acquisition unit, a keyword belonging to a property identical to the property determined for the insertion section of the template selected from the template storage unit by the template selection unit, and inserting the selected keyword into the insertion section of the template, thereby generating a catch phrase.

6. The computer-readable recording medium that records the catch phrase generation program according to claim 5,
wherein there is further provided conversion keyword storage unit that stores, in association with the keyword, a conversion keyword belonging to a property having a meaning associated with the keyword and different from the property of the keyword, and
wherein when the property of the keyword acquired by the keyword acquisition unit is not identical to the property determined for the insertion section of the template selected from the template storage unit, the catch phrase generation program allows the catch phrase generation unit to function to make reference to the conversion keyword storage unit, to convert the keyword, acquired by the keyword acquisition unit, into a conversion keyword the property of which is identical to the property of the insertion section, and to insert the converted keyword into the insertion section of the template, thereby generating a catch phrase.

7. The computer-readable recording medium that records the catch phrase generation program according to claim 6,
wherein the template storage unit stores, in a grouped manner, a plurality of templates,
wherein the conversion keyword storage unit further stores the degree of association between the keyword and the conversion keyword,
wherein the catch phrase generation program allows the template selection unit to function to select, from the template storage unit, a group of templates corresponding to the guidance information based on a predetermined condition, and
wherein the catch phrase generation program allows the catch phrase generation unit to function to insert a keyword acquired by the keyword acquisition unit or a conversion keyword into an insertion section of each template included in the template group selected by the template selection unit, to calculate a first association value based on the degree of association of the inserted keyword or conversion keyword stored in the conversion keyword storage unit, and on the timing of an access history analyzed by the keyword acquisition unit, and to determine, as a catch phrase, a template having the highest calculated first association value.

8. The computer-readable recording medium that records the catch phrase generation program according to claim 7,
wherein the catch phrase generation program allows the computer to function as guidance point acquisition unit for segmenting the guidance information into words, and acquiring, when the segmented words are stored in the keyword storage unit, the words and properties as guidance points, and
wherein the catch phrase generation program allows the catch phrase generation unit to function to calculate a second association value based on the degree of association of the inserted keyword or conversion keyword, and on the guidance points acquired by the guidance point acquisition unit, and to further use the first association value and the calculated second association value to select a catch phrase from the plurality of templates.
